(19) United States
(12) Patent Application Publication
(10) Pub. No.: US 2026/0154962 A1
(43) Pub. Date: Jun. 4, 2026

(54) MACHINE LEARNING BASED VIDEO ANALYSIS, DETECTION AND PREDICTION

(71) Applicant: Cornell University, Ithaca, NY (US)

(72) Inventors: Junyi Dong, Ithaca, NY (US); Silvia Ferrari, Ithaca, NY (US); Qingze Huo, Ithaca, NY (US); Choong Hee Kim, Ithaca, NY (US)

(21) Appl. No.: 18/706,286

(22) PCT Filed: Nov. 7, 2022
(86) PCT No.: PCT/US2022/049115

§ 371 Date: Apr. 30, 2024

Related U.S. Application Data
(60) Provisional application No. 63/276,305, filed on Nov. 5, 2021.

(51) Int. Cl. G06V 20/40; G06N 3/045; G06V 10/82; G06V 10/84; H04N 23/60

(52) U.S. Cl. CPC G06V 20/42; G06N 3/045; G06V 10/82; G06V 10/85; G06V 20/46; H04N 23/60

(57) ABSTRACT

A method comprises obtaining video data from one or more data sources, and processing the obtained video data in a machine learning system comprising an inference stage and an anticipation stage. The inference stage is configured to assign one or more labels to at least one of a group activity and an individual activity detected in the obtained video data. The anticipation stage is configured to predict one or more future actions relating to at least one of the group activity and the individual activity based at least in part on the one or more labels assigned in the inference stage. The method further comprises generating at least one control signal based at least in part on the predicted one or more future actions. The method is illustratively configured to implement role inference and action anticipation in team sports, although it is applicable to a wide variety of other contexts.

### RELATED APPLICATION

The present application claims priority to U.S. Provisional Patent Application Ser. No. 63/276,305, filed Nov. 5, 2021 and entitled “Machine Learning Based Video Analysis, Detection and Prediction,” which is incorporated by reference herein in its entirety.

### STATEMENT OF GOVERNMENT SUPPORT

This invention was made with U.S. government support under Grant No. N00014-17-1-2175 of the Office of Naval Research (ONR). The U.S. government has certain rights in the invention.

### FIELD

The field relates generally to information processing, including video processing for intelligent prediction and decision making.

### BACKGROUND

Anticipating human actions directly from video data is a critical skill for many future cyber-physical systems, such as robots and autonomous sensors. Despite the recent development of powerful computer vision algorithms that extract visual features and information that is explicit in nature, such as color, appearance, and positions, human action anticipation in social situations remains a difficult task because it requires not only explicit visual features but also past experience, implicit context, hidden cues, and inferred relationships that cannot be readily extracted from a scene. The technical challenge is further exacerbated when the scope of action anticipation is to anticipate actions by a team of individuals, such as team sports, where the team strategy and circumstances of play are dynamic and depend on the adversary team, thus adding extra layers of complexity to the action anticipation task.

### SUMMARY

Illustrative embodiments disclosed herein provide techniques for machine learning based video analysis, detection and prediction. For example, some embodiments include systems that are configured to provide role inference and action anticipation in the context of team sports, although it is to be appreciated that the disclosed techniques are more widely applicable to numerous other video processing contexts. Also, illustrative embodiments herein can process a wide variety of different types of video data and/or other sensor data. For example, the disclosed embodiments can be configured to integrate video data with data from one or more other distinct sensor modalities.

Some embodiments provide, for example, a unified framework that includes an inference stage and an anticipation stage for forecasting actions in team sports, which captures one or more significant characteristics of human team activities, such as dynamic scenes, group interactions and diverse human actions.

In an example inference stage, the team strategy and the role of a player, two hidden variables in a scene of a team sport, are inferred via a multi-class classifier and a spatio-temporal Markov Random Field (MRF) model, respectively. Alternative classifiers and models can be used for team strategy inference and player role inference in other embodiments.

In an example anticipation stage, by integrating the inference results with visual observations, a multi-layer perceptron (MLP) or other type of neural network is configured for anticipating future actions of key players in an online fashion, allowing the anticipation output to evolve over time. Other types of machine learning arrangements can be used for action anticipation in other embodiments.

Experiments conducted using real-world volleyball videos show that the average precision and recall in one embodiment are approximately 0.81 and 0.83, respectively. Other embodiments can provide similarly advantageous results for numerous other team inference and anticipation problems, and in a wide variety of other contexts.

In one embodiment, a method for determining the role of sport players in streaming videos is provided. The method illustratively comprises recognizing a semantic label that describes the team activity at each frame and identifying a role label for each player that indicates the expected responsibility of that player.

Additionally or alternatively, a method is provided for anticipating future actions of players. The method illustratively comprises predicting a sub-group of key players who are likely to interact with a ball or the like and therefore influence the play, and anticipating the unseen future actions of players based on the inferred team activity label and role label.

These and other embodiments have application to sports analytics and the video game industry, the control of video cameras, and to numerous other contexts, including contexts involving automated robots and sensors. For example, illustrative embodiments disclosed herein are implemented in applications that include camera control in sports photography, and decision making of robotic players, among numerous other applications.

In one embodiment, a method illustratively comprises obtaining video data from one or more data sources, and processing the obtained video data in a machine learning system comprising an inference stage and an anticipation stage, the inference stage being configured to assign one or more labels to at least one of a group activity and an individual activity detected in the obtained video data, and the anticipation stage being configured to predict one or more future actions relating to at least one of the group activity and the individual activity based at least in part on the one or more labels assigned in the inference stage. The method further comprises generating at least one control signal based at least in part on the predicted one or more future actions. The method is illustratively configured to implement role inference and action anticipation in team sports, although it is applicable to a wide variety of other video analysis, detection and prediction contexts.

As another example, some embodiments are configured to process video data and/or other sensor data, and possibly also domain knowledge comprising prior information about a team and a sport, using a machine learning system comprising an inference stage and an anticipation stage, where the inference stage is illustratively configured to assign one or more semantic labels to dynamic group activities, as well as to infer labels of individual activity extracted from video and/or other sensor data. The inference results are illustratively utilized to predict multiple sequential future human actions for at least one of group and individual activities. Some embodiments may further include generating decision-making signals and other intelligent control signals based at least in part on the prediction of future actions, possibly combined with other information such as present team estimates. Again, although some embodiments are illustratively configured to implement role inference and action anticipation in the context of team sports, these and other embodiments disclosed herein are applicable to numerous other contexts in video and/or other sensor data analysis and human behavior prediction.

It is to be appreciated that the foregoing arrangements are only examples, including examples of potential applications of the disclosed techniques, and numerous alternative arrangements are possible.

These and other illustrative embodiments include but are not limited to systems, methods, apparatus, processing devices, integrated circuits, and computer program products comprising processor-readable storage media having software program code embodied therein.

### BRIEF DESCRIPTION OF THE FIGURES

FIG. 1 shows an information processing system comprising a processing platform implementing machine learning based video analysis, detection and prediction in an illustrative embodiment.

FIG. 2 illustrates an example processing flow in an information processing system implementing machine learning based video analysis, detection and prediction in an illustrative embodiment.

FIG. 3 shows an example temporal evolution of team strategies in a volleyball game.

FIG. 4 illustrates example player roles in a volleyball game.

FIG. 5 shows an example graphical model for player role inference in an illustrative embodiment.

FIG. 6 shows another example graphical model with an empty arc set, a sparse arc set and a dense arc set in an illustrative embodiment.

FIG. 7 shows an example spatio-temporal Markov Random Field (MRF) model for modeling player roles in an illustrative embodiment.

FIG. 8A shows example input and output segments and a corresponding simplified instantaneous representation for action anticipation of a key player in an illustrative embodiment.

FIG. 8B shows an example of an anticipated action for a key player in a particular frame of a video signal.

FIG. 9 shows an example neural network comprising a multi-layer perceptron (MLP) for action anticipation in an illustrative embodiment.

FIGS. 10 and 11 illustrate the operation of an information processing system with machine learning based video analysis, detection and prediction implemented in a camera control application in illustrative embodiments.

FIG. 12 is a flow diagram of an example process for decision making of robotic players using machine learning based video analysis, detection and prediction in an illustrative embodiment.

FIG. 13 is a flow diagram of an example process for decision making of artificial players using machine learning based video analysis, detection and prediction in an illustrative embodiment.

FIG. 14 is a flow diagram of an example process for automated generation of player statistics using machine learning based video analysis, detection and prediction in an illustrative embodiment.

### DETAILED DESCRIPTION

Illustrative embodiments can be implemented, for example, in the form of information processing systems comprising one or more processing platforms each having at least one computer, server or other processing device. A number of examples of such systems will be described in detail herein. It should be understood, however, that embodiments disclosed herein are more generally applicable to a wide variety of other types of information processing systems and associated computers, servers or other processing devices or other components. Accordingly, the term “information processing system” as used herein is intended to be broadly construed so as to encompass these and other arrangements.

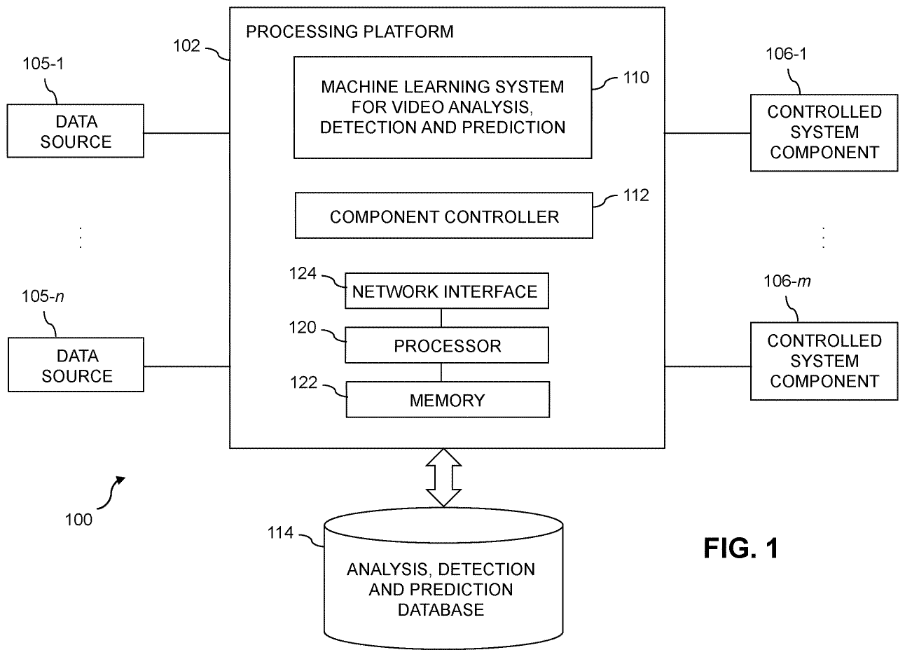

FIG. 1 shows an information processing system 100 implementing machine learning based video analysis, detection and prediction in an illustrative embodiment. The system 100 comprises a processing platform 102. Coupled to the processing platform 102 are data sources 105-1, 105-n and controlled system components 106-1, . . . 106-m, where n and m are arbitrary integers greater than or equal to two and may but need not be equal. Other embodiments can include only a single data source and/or only a single controlled system component. Additionally or alternatively, different ones of the data sources 105 and the controlled system components 106 may represent the same processing device, or different components of that same processing device, such as a smart phone or other user device of a particular system user.

The processing platform 102 comprises a machine learning system 110 and at least one component controller 112. The machine learning system 110 in the present embodiment more particularly implements one or more machine learning algorithms, such as machine learning based video analysis, detection and prediction algorithms of the type described elsewhere herein, although other arrangements are possible.

In operation, the processing platform 102 is illustratively configured to obtain video data from one or more of the data sources 105, and to process the obtained data in the machine learning system 110. As described in more detail elsewhere herein, the machine learning system 110 illustratively comprises at least an inference stage and an anticipation stage. It may comprise one or more additional stages, such as one or more preprocessing stages for preprocessing the obtained video data before processing of the resulting preprocessed video data in the inference and anticipation stages of the machine learning system 110. Alternatively, such preprocessing operations can be performed elsewhere in the processing platform 102, or in a separate external processing device.

The term “obtained video data” as used herein is intended to be broadly construed, so as to encompass, for example, preprocessed video data derived from input video data received from one or more of the data sources 105, such as one or more video cameras, image sensors, databases, websites, content distribution networks, broadcast networks and/or other types of sources of one or more video signals, as well as metadata, descriptive information, contextual information, and/or other types of information associated with the one or more video signals, all or at least portions of which are intended to be encompassed by the broad term “obtained video data” as used herein. Accordingly, in some embodiments, obtaining video data from one or more data sources illustratively comprises fusing and integrating feature extraction from video data with related information from one or more other data sources. The resulting fused and integrated information in these and other embodiments is considered another example of “obtained video data” as that term is broadly used herein. Obtained video data in some embodiments can therefore include, for example, video data extracted from one or more video signals, integrated with data from one or more other sensor modalities.

The inference stage of the machine learning system 110 is illustratively configured to assign one or more labels to at least one of a group activity and an individual activity detected in the obtained video data. The labels illustratively include contextual labels, although additional or alternative labels could be used.

In some embodiments, the inference stage is configured to assign a group activity label to a group activity utilizing a multi-class classifier, possibly implemented using one or more neural networks.

Additionally or alternatively, in some embodiments, the inference stage is configured to assign an individual activity label to an individual activity utilizing a spatio-temporal Markov Random Field (MRF) model, illustratively a new type of dynamic spatio-temporal MRF model described in more detail elsewhere herein, although it is to be appreciated that other models can be used.

The anticipation stage of the machine learning system 110 is illustratively configured to predict one or more future actions relating to at least one of the group activity and the individual activity based at least in part on the one or more labels assigned in the inference stage.

For example, the anticipation stage may be configured to predict multiple sequential future actions relating to at least one of group and individual activities, based at least in part on contextual labels assigned in the inference stage and on learned experience from past data.

In some embodiments, the anticipation stage is configured to predict the one or more future actions utilizing a multi-layer perceptron (MLP), or another type of neural network. Again, other machine learning models or algorithms may be used. The term “anticipation stage” as used herein is therefore intended to be broadly construed, and should not be viewed as limited to any particular type of prediction. Similarly, the term “inference stage” as used herein is also intended to be broadly construed.

The assignment of one or more labels in the inference stage and the prediction of one or more future actions in the anticipation stage are illustratively repeated for each of a plurality of frames of the obtained video data.

For example, the assignment of hidden contextual labels, such as stage of play, strategy, and role, in the inference stage and the prediction of future human actions in the anticipation stage are illustratively repeated for each of a plurality of frames of the obtained video data.

The processing platform 102 is further configured to generate in component controller 112 at least one control signal based at least in part on the predicted one or more future actions determined in the anticipation stage of the machine learning system 110. Additionally or alternatively, such a control signal may be generated within the machine learning system 110, and may comprise, for example, one or more outputs of the inference stage and/or the anticipation stage of the machine learning system 110.

The control signal in some embodiments is illustratively configured to trigger at least one automated action in at least one processing device that implements the processing platform 102, and/or in at least one additional processing device external to the processing platform 102. For example, the control signal may be transmitted over a network from a first processing device that implements at least a portion of the machine learning system 110 to trigger at least one automated action in a second processing device that comprises at least one of the controlled system components 106.

As a more particular example, the control signal generated by the processing platform 102 illustratively comprises at least one camera control signal configured to automatically adjust one or more parameters of at least one camera system.

Additionally or alternatively, one or more camera control signals generated by the processing platform 102 can be configured to automatically plan the motion of a camera, such as a camera installed on a drone or on another type of unmanned platform, and/or to adjust one or more camera parameters such as pan, tilt, and zoom.

As yet another example, the control signal generated by the processing platform 102 illustratively comprises at least one automated player control signal configured to automatically adjust one or more parameters of at least one automated player. The automated player may comprise, for example, one of a robotic player in a physical game system and a virtual player in a gaming system. Such players in some embodiments are also referred to herein as “artificial players.”

In some embodiments, the control signal generated by the processing platform 102 illustratively comprises at least one automated player control signal generated, for example, as part of an interactive video game or live training session. The control signal is configured to automatically decide and control the motion of at least one automated player or player formation for a given team, and to optimize actions or parameters in reaction to an opposing team. The automated player may comprise, for example, a cyber-physical robotic player in a hybrid human-robot physical game scenario. As indicated above, similar techniques can be applied to virtual players in a gaming system, and to other types of automated players, including artificial players as referred to elsewhere herein.

In some embodiments, the machine learning system 110 is configured to anticipate the future actions of one or more players. For example, the machine learning system 110 illustratively implements an algorithm that integrates observed player actions with contextual information of inferred team activity and player role labels as inputs to anticipate a future action as well as the starting time and/or duration of the future action.

These and other embodiments can be used to augment or substitute a human performance analyst, by assessing a team's performance in a sport to plan actions that inform decision making, optimize performance and support coaches and players in optimal training and game preparation. For example, algorithms of the type disclosed herein can be applied to many team sports for tactical assessment, movement analysis, video and statistical integration, and modeling of adversaries for coach and player use and representation.

In some embodiments, the techniques disclosed herein can be applied to implement video games that animate virtual players. For example, in order to program an animated volleyball player that appears and behaves like a professional player, the animated player should acquire the anticipatory ability of forecasting the future actions of other players, which can be achieved by applying the disclosed techniques.

In some embodiments, the anticipation stage of the machine learning system 110 is configured to predict the one or more future actions based at least in part on a probability distribution of multiple predicted actions. In such an embodiment, the control signal is illustratively generated based at least in part on selection of a particular one of the multiple predicted actions utilizing the probability distribution.

Additionally or alternatively, a probability distribution of multiple predicted action sequences can be generated, and processed in a manner similar to that described above and elsewhere herein. The term “action” as used herein is intended to be broadly construed, so as to encompass a sequence of one or more actions.

In some embodiments, the group activity comprises a team sports activity and the individual activity comprises a player activity associated with the team sports activity. In some embodiments of this type, the inference stage of the machine learning system 110 is configured to assign a team activity label to the team sports activity and to assign a role label to each of a plurality of players associated with respective player activities of the team sports activity, and the anticipation stage is configured to predict the one or more future actions by predicting a sub-group of key players in the plurality of players and predicting at least one future action for at least one of the key players based at least in part on an inferred team activity label and one or more inferred role labels for respective ones of the plurality of players.

As another example, some embodiments are configured to process video data as well as prior information about a team, using a machine learning system comprising an inference stage and an anticipation stage, where the inference stage is illustratively configured to assign one or more semantic labels to dynamic group activities, as well as to infer labels of individual activity extracted from video data. The inference results are illustratively utilized to predict multiple sequential future human actions for at least one of group and individual activities. Some embodiments include generating decision-making signals and other intelligent control signals based at least in part on the prediction of future actions, possibly combined with other information such as present team estimates. Again, although this example is illustratively configured to implement role inference and action anticipation in the context of team sports, these and other embodiments disclosed herein are applicable to numerous other contexts in video analysis and human behavior prediction.

In some embodiments, the inference stage is configured to determine one or more hidden contextual labels to at least one of a group activity and an individual activity detected in the obtained video data, illustratively based at least in part on integrated past visual features and other information extracted using computer vision or other techniques. The anticipation stage in one or more such embodiments is illustratively configured to predict multiple sequential future actions relating to both group activity and individual activities based at least in part on the one or more labels assigned in the inference stage, possibly in combination with other information such as instantaneous scene estimates and features.

The video data processed by the machine learning system 110 in some embodiments can be obtained from one or more video cameras, image sensors, databases, websites, content distribution networks, broadcast networks and/or other sources of one or more video streams. Such components are examples of data sources 105, and additional or alternative data sources 105 can be used in other embodiments, as indicated above.

It is to be appreciated that the term “machine learning system” as used herein is intended to be broadly construed to encompass at least one machine learning algorithm configured for at least one of analysis, detection and prediction using one or more machine learning techniques. The processing platform 102 may therefore be viewed as an example of a “machine learning system” as that term is broadly used herein. More detailed examples of particular implementations of machine learning algorithms implemented by machine learning system 110 are described elsewhere herein.

The component controller 112 generates one or more control signals for adjusting, triggering or otherwise controlling various operating parameters associated with the controlled system components 106 based at least in part on predictions or other outputs generated by the machine learning system 110. A wide variety of different types of devices or other components can be controlled by component controller 112, possibly by applying control signals or other signals or information thereto, including additional or alternative components that are part of the same processing device or set of processing devices that implement the processing platform 102 and/or one or more of the data sources 105. Such control signals, and additionally or alternatively other types of signals and/or information, can be communicated over one or more networks to other processing devices, such as user terminals or other user devices associated with respective system users.

In some embodiments, the component controller 112 can be implemented within the machine learning system 110, rather than as a separate element of processing platform 102 as shown in the figure.

The processing platform 102 is configured to utilize an analysis, detection and prediction database 114. Such a database illustratively stores team and player data, profiles and a wide variety of other types of information, including data from one or more of the data sources 105, illustratively utilized by the machine learning system 110 in performing video analysis, detection and prediction operations. The analysis, detection and prediction database 114 is also configured to store related information, including various processing results, such as predictions or other outputs generated by the machine learning system 110.

The component controller 112 utilizes outputs generated by the machine learning system 110 to control one or more of the controlled system components 106. The controlled system components 106 in some embodiments therefore comprise system components that are driven at least in part by outputs generated by the machine learning system 110. For example, a controlled system component can comprise at least one processing device, such as a computer, mobile telephone, camera system, robotic player, gaming system or other processing device, configured to automatically perform a particular function in a manner that is at least in part responsive to an output of a machine learning system. These and numerous other different types of controlled system components 106 can make use of outputs generated by the machine learning system 110, including various types of equipment and other systems associated with one or more of the example applications described elsewhere herein.

Although the machine learning system 110 and the component controller 112 are both shown as being implemented on processing platform 102 in the present embodiment, this is by way of illustrative example only. In other embodiments, the machine learning system 110 and the component controller 112 can each be implemented on a separate processing platform. A given such processing platform is assumed to include at least one processing device comprising a processor coupled to a memory.

Examples of such processing devices include computers, servers or other processing devices arranged to communicate over a network. Storage devices such as storage arrays or cloud-based storage systems used for implementation of analysis, detection and prediction database 114 are also considered “processing devices” as that term is broadly used herein.

The network can comprise, for example, a global computer network such as the Internet, a wide area network (WAN), a local area network (LAN), a satellite network, a telephone or cable network, a cellular network such as a 4G or 5G network, a wireless network implemented using a wireless protocol such as Bluetooth, WiFi or WiMAX, or various portions or combinations of these and other types of communication networks.

It is also possible that at least portions of other system elements such as one or more of the data sources 105 and/or the controlled system components 106 can be implemented as part of the processing platform 102, although shown as being separate from the processing platform 102 in the figure.

For example, in some embodiments, the system 100 can comprise a laptop computer, tablet computer or desktop personal computer, a mobile telephone, a gaming system, or another type of computer or communication device, as well as combinations of multiple such processing devices, configured to incorporate at least one data source and to execute a machine learning system for controlling at least one system component.

Examples of automated actions that may be taken in the processing platform 102 responsive to outputs generated by the machine learning system 110 include generating in the component controller 112 at least one control signal for controlling at least one of the controlled system components 106 over a network, generating at least a portion of at least one output display for presentation on at least one user terminal, generating an alert for delivery to at least one user terminal over a network, and/or storing the outputs in the analysis, detection and prediction database 114.

A wide variety of additional or alternative automated actions may be taken in other embodiments. The particular automated action or actions will tend to vary depending upon the particular application in which the system 100 is deployed.

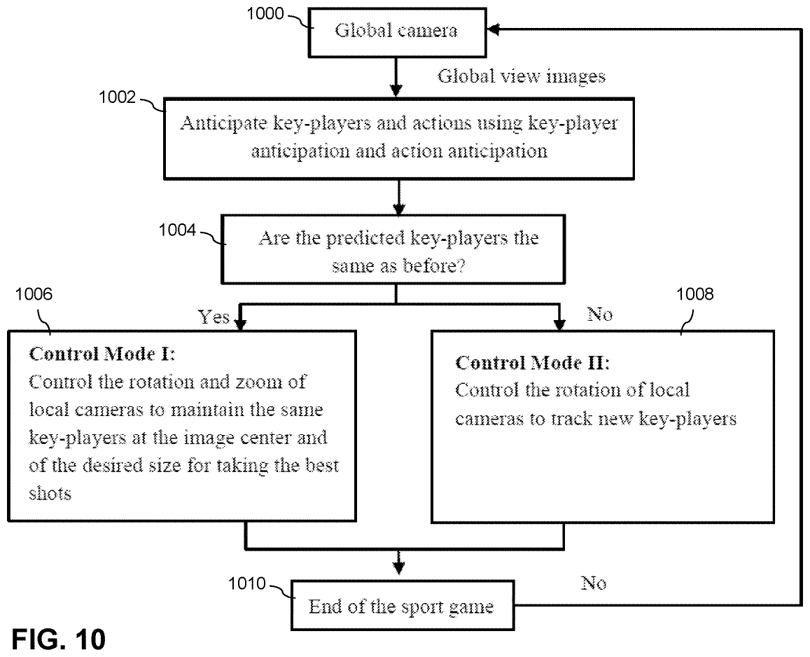

For example, some embodiments disclosed herein implement machine learning based video analysis, detection and prediction to at least partially automate various aspects of camera control and robotic or artificial player control, as will be described in more detail below in conjunction with the illustrative embodiments of FIGS. 10 through 13.

Examples of automated actions in these particular contexts include generating at least one control signal, such as a local camera control signal or a robotic player control signal, for utilization in a local camera or a robotic player, respectively.

Additional examples of applications are provided elsewhere herein. It is to be appreciated that the term “automated action” as used herein is intended to be broadly construed, so as to encompass the above-described automated actions, as well as numerous other actions that are automatically driven based at least in part on outputs of a machine learning based video analysis, detection and prediction algorithm as disclosed herein.

The processing platform 102 in the present embodiment further comprises a processor 120, a memory 122 and a network interface 124. The processor 120 is assumed to be operatively coupled to the memory 122 and to the network interface 124 as illustrated by the interconnections shown in the figure.

The processor 120 may comprise, for example, a microprocessor, an application-specific integrated circuit (ASIC), a field-programmable gate array (FPGA), a central processing unit (CPU), a graphics processing unit (GPU), a tensor processing unit (TPU), an arithmetic logic unit (ALU), a digital signal processor (DSP), or other similar processing device component, as well as other types and arrangements of processing circuitry, in any combination. At least a portion of the functionality of at least one machine learning system and its associated video analysis, detection and prediction algorithms provided by one or more processing devices as disclosed herein can be implemented using such circuitry.

In some embodiments, the processor 120 comprises one or more graphics processor integrated circuits. Such graphics processor integrated circuits are illustratively implemented in the form of one or more GPUs. Accordingly, in some embodiments, system 100 is configured to include a GPU-based processing platform. Such a GPU-based processing platform can be cloud-based configured to implement one or more machine learning systems for processing data associated with a large number of system users. Similar arrangements can be implemented using TPUs and/or other processing devices.

Numerous other arrangements are possible. For example, in some embodiments, a machine learning system can be implemented on a single processor-based device, such as a smart phone, client computer or other user device, utilizing one or more processors of that device. Such embodiments are also referred to herein as “on-device” implementations of machine learning systems.

The memory 122 stores software program code for execution by the processor 120 in implementing portions of the functionality of the processing platform 102. For example, at least portions of the functionality of machine learning system 110 and component controller 112 can be implemented using program code stored in memory 122.

A given such memory that stores such program code for execution by a corresponding processor is an example of what is more generally referred to herein as a processor-readable storage medium having program code embodied therein, and may comprise, for example, electronic memory such as SRAM, DRAM or other types of random access memory, flash memory, read-only memory (ROM), magnetic memory, optical memory, or other types of storage devices in any combination.

Articles of manufacture comprising such processor-readable storage media are considered embodiments of the present disclosure. The term “article of manufacture” as used herein should be understood to exclude transitory, propagating signals.

Other types of computer program products comprising processor-readable storage media can be implemented in other embodiments.

In addition, illustrative embodiments may be implemented in the form of integrated circuits comprising processing circuitry configured to implement processing operations associated with one or both of the machine learning system 110 and the component controller 112 as well as other related functionality. For example, at least a portion of the machine learning system 110 is illustratively implemented in at least one neural network integrated circuit of a processing device of the processing platform 102.

The network interface 124 is configured to allow the processing platform 102 to communicate over one or more networks with other system elements, and may comprise one or more conventional transceivers.

It is to be appreciated that the particular arrangement of components and other system elements shown in FIG. 1 is presented by way of illustrative example only, and numerous alternative embodiments are possible. For example, other embodiments of information processing systems can be configured to implement machine learning system functionality of the type disclosed herein.

Terms such as “data source” and “controlled system component” as used herein are intended to be broadly construed. For example, a given set of data sources in some embodiments can comprise one or more video cameras, sensor arrays or other types of imaging or data capture devices, or combinations thereof, possibly associated with smartphones, wearable devices, sensors or other arrangements of user devices or other processing devices. Other examples of data sources include various types of databases or other storage systems accessible over a network. A wide variety of different types of data sources can be used to provide input data to a machine learning system in illustrative embodiments. A given controlled system component can illustratively comprise a computer, mobile telephone, camera system, robotic player, gaming system or other processing device that receives an output from a machine learning system and performs at least one automated action in response thereto. The machine learning system and the given controlled system component can be part of the same processing device.

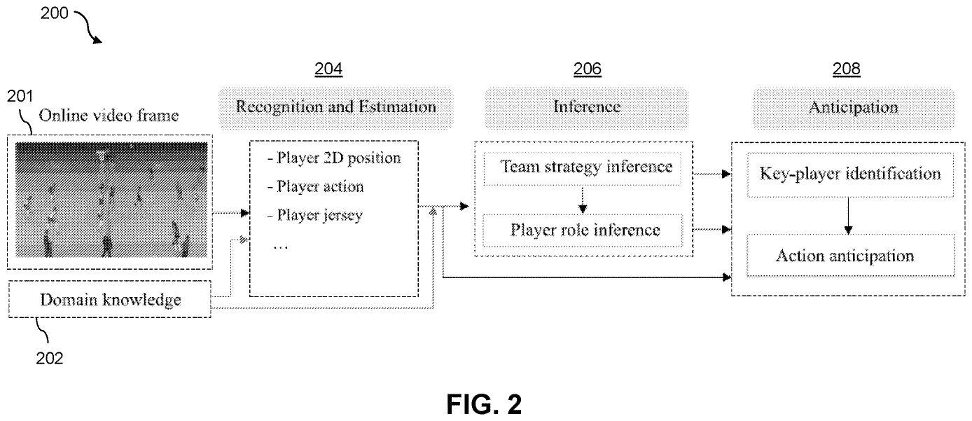

Additional illustrative embodiments will now be described with reference to FIGS. 2 through 9. These embodiments and others herein are described in the context of a particular team sports activity, illustratively a volleyball game, but it is to be appreciated that the disclosed techniques can be adapted in a straightforward manner to a wide variety of other team sports activities, and still more generally to other types of group activities that are not necessarily in the field of sports.

Some of the embodiments to be described provide a holistic approach for interpreting and predicting team behaviors, demonstrated herein in the context of a challenging problem, namely, anticipating fast actions executed by interacting members of a sport team. In a team sport, such as volleyball, the team strategy and circumstances of play are not only hidden and directly influence individual actions, but also are highly dynamic, in that they change significantly and rapidly over time. Additionally, individual players assume different roles during the game, contributing in different measure to game strategy and outcome, thus influencing their teammates' behaviors in contrasting ways. The team strategy and players' roles are, almost by definition, hidden or unobservable. In other words, they are not visually explicit in the scene, but they can be inferred from a combination of visual cues and domain knowledge of the sport and of the team itself, as will be described in more detail elsewhere herein.

Illustrative embodiments provide significant advantages over conventional approaches to the problem of group activity recognition, which generally seek to identify an activity label for a group of participants. For example, these conventional approaches typically require the user to pre-select a time window that centers around a group activity by manually clipping the video or choosing the initial and final image frames. As such, these conventional approaches cannot be easily extended to dynamic settings where the team strategies evolve over time, gradually or suddenly at unknown instants. In contrast, illustrative embodiments disclosed herein infer the team strategy label in each frame, based on which the input video can be automatically partitioned into scene segments for action anticipation. These and other embodiments are advantageously configured to accommodate rapid changes in roles. For example, in many events, such as sports, the individual role changes over time as a function of an evolving group activity/strategy, without the need for categorizing interdependence between team strategies and players' roles into a set of semantic classes identifiable a priori.

Some embodiments provide a novel dynamic Markov random field (DMRF) model that captures players' interrelationships using a dynamic graph structure, and learns individual player characteristics in the form of a feature vector based on a wealth of prior information, including domain knowledge, such as court dimensions and sport rules, and visual cues, such as homography transformations, and players' actions and jerseys. The DMRF unary and pairwise potentials can then be learned from data to represent the probability of individual feature realizations and the strengths of the corresponding players' interrelationships, respectively. Each new video frame is associated with a global hidden variable that describes the team strategy, within which each player is assigned a local hidden variable representing her/his role on the team. Then, given video frames of an ongoing game, the DMRF can be used to infer the players' roles using a Markov chain Monte Carlo (MCMC) sampling method, and to provide inputs to a multi-layer perceptron (MLP) that anticipates the players' future actions.

The notion of key player is introduced to distinguish a small set of players who will perform dominant actions that directly influence the game progress. In the anticipation stage, an MLP is trained to predict future actions of key players based on visual features as well as the inference results. Action anticipation is performed in each frame such that the anticipated results can be updated in a timely manner as the future unfolds. The anticipation MLP in some embodiments is configured to simultaneously output the semantic label, onset and duration of the key players' future actions. Some embodiments herein provide a distinctively new variant of visual forecasting problem that anticipates future action in human teams. By providing new problem formulations and solutions for team action anticipation, the holistic approach provided in some embodiments herein is configured to account for the implicit context, perceived through several inferred hidden variables, as well as for hybrid inputs comprised spatio-temporal relationships, continuous variables, and categorical features that together describe the team players and their interactions. As will be described in more detail elsewhere herein, the results obtained on a testing database constructed from broadcasting videos of volleyball games demonstrate that this example approach predicts the future actions of key players up to 46 frames into the future, with an accuracy of 80.50%. In addition, the example approach achieves an average accuracy of 84.43% and 86.99% for inferring the team strategy and players' roles, respectively.

An exemplary role inference and action anticipation approach in illustrative embodiments herein is demonstrated on the team sport of volleyball, described here briefly for completeness. However, the example approach can be similarly applied to other team sports and activities, as will be apparent to those skilled in the art.

FIG. 2 illustrates an example processing flow in an information processing system 200 implementing machine learning based video analysis, detection and prediction in an illustrative embodiment.

In this embodiment, video frames of a video of a volleyball game, illustratively including example online video frame 201, are obtained and processed along with domain knowledge 202. The processing flow as illustrated includes a recognition and estimation stage 204 that processes inputs including the online video frame 201 and domain knowledge 202 to determine information including player two-dimensional (2D) position, player action, player jersey, and possibly additional or alternative recognition and estimation information. The information processing system 200 implements a machine learning system that includes an inference stage 206 and an anticipation stage 208. The inference stage 206 in this embodiment is configured to perform both team strategy inference and player role inference, as illustrated. The anticipation stage 208 in this embodiment is configured to perform key player identification and action anticipation, also as illustrated. The domain knowledge 202 is utilized in one or more of the stages 204, 206 and 208. Additional or alternative stages, involving processing operations other than those specifically illustrated, can be utilized in other embodiments.

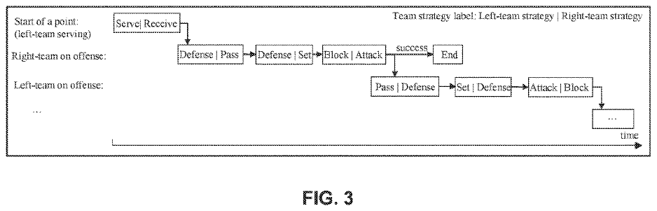

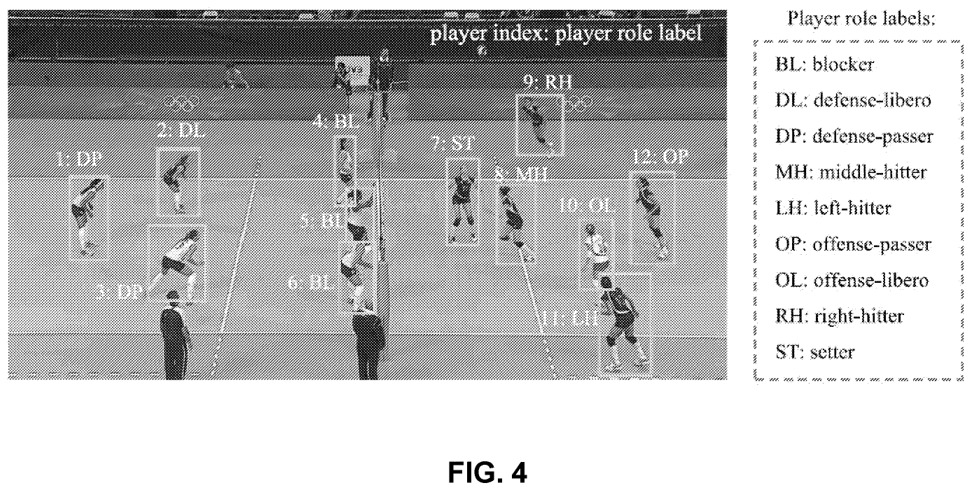

FIGS. 3 and 4 show examples of team strategies and player roles, respectively, in a volleyball game.

A typical volleyball game includes five sets that are further broken into points. Each point starts with a player serving the ball to the opposite side. Each team attempts to avoid letting the ball be grounded within their own court by hitting the ball to the opponent after no more than three consecutive touches of the ball by three different players.

The game continues until the ball is grounded, with the players moving around their own side of the court and assuming different roles over time, such as blocker, defense-libero, left-hitter, and so on, as illustrated in FIG. 4. This alternating pattern can be reflected by the transition of a finite class of team strategy labels, whose semantic meaning describes the technical activity of the two teams. For instance, as illustrated in FIG. 3, the team strategy labels can indicate that the right team is setting the ball for the next-step attack and the left team is on defense, or that the right is attacking and the left is blocking.

The two teams are divided by a net in the middle of the court, which simplifies the action anticipation problem compared to other team sports, such as football or hockey. As in other sports, each team is represented by a jersey color. However, in volleyball, some players within a team also wear a different jersey to indicate their “libero position” on the team. For effective coordination, players assume different roles in accordance with their expected duty in the team. Consequently, each player can be assigned a semantic role label that serves as an abstract representation of the player's intentions and possible actions. Although an example description of nine possible player roles is shown in FIG. 4, additional or alternative player roles can be used in other embodiments. An additional complexity in this example team sport context is that the player roles change rapidly and unexpectedly over time, and some of the players can assume the same role at the same time.

Volleyball actions can be categorized, for example, into nine well-defined classes: spiking, blocking, setting, running, digging, standing, falling, waiting, and jumping, as extracted using computer vision algorithms. However, actions are not unique to players' roles, nor is there any precise correspondence (e.g., one-to-one) between roles and actions. In some embodiments, the action label waiting is replaced with squatting for a closer clarification on this defensive action that happens before a player digs the ball.

During the volleyball game, players do not contribute equally. Rather, only a subset of players, referred to as key players, are actively engaged while the others are waiting for their turns to enter into action. For instance, player 7 in FIG. 4 is a key player because her future action of setting will dominate the game.

Aspects of problem formulation and assumptions in illustrative embodiments will now be described. It is to be appreciated that these aspects are only examples, and can be varied in other embodiments.

Some embodiments herein are configured to address an action anticipation problem. This illustratively involves anticipating future actions by multiple key players in a team sport (e.g., volleyball) based at least in part on hidden information, such as players' roles and team strategy, domain knowledge, and visual features extracted from video using existing computer vision algorithms. Such embodiments provide a general and systematic approach for interpreting visual scenes of human group activities with complex goals, dynamic behaviors, and variegated interactions.

Although illustrative embodiments mainly consider video data, the disclosed framework can be readily applied to data obtained from other sensor modalities, in addition to or in place of video data. Examples of other sensor modalities that may be utilized in illustrative embodiments in addition to or in place of video data include range finders, inertial navigation units, and wearable sensors (e.g., sensors disposed at one or relevant body landmarks such as, but not limited to, hands, feet, joints, head, etc. to provide positional and/or velocity and/or acceleration information relating to the body landmark(s)). In some embodiments, the video data and data from one or more other sensor modalities are integrated within the disclosed framework. In other embodiments, such sensor modality data is applied within the disclosed framework in lieu of, and without reliance upon, video data.

The example approach of some illustrative embodiments is holistic in that it integrates image recognition, namely the classification of visually explicit information, state estimation, inference of hidden variables, and anticipation of future actions and events, as will now be described in more detail.

As illustrated in FIG. 2, an example approach involves using information extracted from video frames and domain knowledge, possibly via image recognition and state estimation algorithms, to solve problems of team/player inference and action anticipation inference formulated in the example manner described below.

### Inference Problem Formulation

Consider by way of illustrative example a video [symbol] comprised of K∈ [symbol] ⁺ consecutive frames obtained at discrete moments in time with a constant sampling interval Δt. Each frame I(k)∈ [symbol] , k=1, . . . K, corresponds to an image matrix of h× [symbol] pixel intensities, where h, [symbol] ∈ [symbol] ⁺ are the frame size. Let [symbol] ={1, . . . , N}, N∈ [symbol] ⁺, denote the index set of players extracted from I(k) using computer vision techniques, such as, for example, Mask R-CNN and/or hierarchical deep temporal models for group activity recognition. The frame index is omitted for [symbol] since the number of players is fixed in a volleyball video.

Each player in frame I(k) can be associated with an index i= [symbol] and a feature descriptor that contains a 2D position vector, an action label, and an appearance feature describing the player's jersey color. Other characteristics and state variables can be similarly included, depending on the application of interest.

$$Let {p}_{i}^{′} ( k ) = {[ {x}_{i}^{′} ( k ) {i}_{′}^{} ( k ) ]}^{T} ∈ {ℝ}^{2 \times 1}$$

denote the 2D position of the ith player with respect to the image frame, which can be approximated by the image coordinate at the bottom middle point of the player's bounding box. In order to gain immediate insight into players' spatial relationship, the position vector

$${p}_{i}^{′} ( k )$$

is resolved into the inertial coordinate denoted by pᵢ(k)=[xᵢ(k) [symbol] ᵢ(k)]^{T}∈ [symbol] ^{2×1}. Because the volleyball court is planar, the image and inertial coordinate can be related via homography transformation H, as follows:

$$λ [ \begin{matrix}{x}_{i}^{′} ( k ) \\ {i}_{′}^{} ( k ) \\ 1\end{matrix} ] = [ \begin{matrix}{H}_{11} & {H}_{12} & {H}_{13} \\ {H}_{21} & {H}_{22} & {H}_{23} \\ {H}_{31} & {H}_{32} & {H}_{33}\end{matrix} ] [ \begin{matrix}{x}_{i} ( k ) \\ {i}_{} ( k ) \\ 1\end{matrix} ] , \qquad ( 1 )$$

where λ≠0 is a scaling factor, and the homography transformation H can be estimated using domain knowledge of court dimensions and the geometry of the lines drawn on the volley ball court. The homography transformation H illustrates an example projection between an inertial reference frame and an image reference frame.

Next, let Aᵢ(k)∈ [symbol] represent the action label of player i∈ [symbol] in an observed frame I(k), where [symbol] is the discrete and finite range of the action classes, which illustratively include spiking, setting, blocking, digging, running, squatting, falling, standing and jumping, although additional or alternative action classes could be used. A player's jersey color is denoted by a discrete variable cᵢ(k)∈ [symbol] , which can be obtained using a color detector of a type known in the art, or as prior knowledge. Together, the aforementioned features can be organized as a player feature vector Fᵢ(k)=[pᵢ(k)^{T} Aᵢ(k) Cᵢ(k)]^{T}.

Then, each frame I(k)∈ [symbol] in a volleyball video can be assigned a semantic label describing the technical strategy of two teams, as illustrated in FIG. 3. Inference of the team strategy utilizes the aggregation of features across players, which amounts to the concatenation of player feature vectors into a frame-wise team descriptor. In order to preserve the spatial relationship in a team, feature vectors of players on each side are sorted by the player's distance to the net. Then, the aggregated team feature descriptor can be constructed as

$$F ( k ) {=}^{Δ} {[ {F}_{{l}_{1}}^{T} ( k ) … {F}_{{l}_{\frac{N}{2}}}^{T} ( 2 ) {F}_{{r}_{1}}^{T} ( k ) … {F}_{{r}_{\frac{N}{2}}}^{T} ( k ) ]}^{T} \qquad ( 2 )$$

with the range denoted by [symbol] and the indices of elements defined by the sorted index set

$$\hat{𝒩} = \{ {l}_{1} , … , {l}_{\frac{N}{2}} , {r}_{1} , … , {r}_{\frac{N}{2}} \} , \qquad ( 3 )$$

where

$$\{ {l}_{1} , … , {l}_{\frac{N}{2}} \} ⊂ \hat{𝒩}$$

represent the sorted indices of players on the left team and

$$\{ {r}_{1} , … , {r}_{\frac{N}{2}} \} ⊂ \hat{𝒩}$$

is the counterpart for the right team.

Let S(k)∈ [symbol] be a global hidden variable representing the team strategy label in frame I(k), where [symbol] is the finite range of the team strategy classes, as illustrated in FIG. 3. In addition, let Xᵢ(k)∈ [symbol] , i∈ [symbol] , be a local hidden variable representing the role of player i. Xᵢ(k) takes a realization from a set of role labels [symbol] , which are illustrated in FIG. 4. The labels of all players' roles can be denoted by a random vector X(k)≙[X₁(k) . . . . X_{N}(k)]^{T} that has a range [symbol] = [symbol] ^{N}. Then, the inference problem can be formulated as follows: Given the extracted features, F(k), learn a multi-class classifier, f_{S}: [symbol] → [symbol] , that maps F(k)∈ [symbol] to a team strategy label S(k)∈ [symbol] . Subsequently, learn an inference model, fₓ: [symbol] × [symbol] → [symbol] , that maps the feature vector F(k) and the inferred team strategy label S(k) to the vector X(k), representing role labels of all players.

### Anticipation Problem Formulation

The action anticipation problem in some embodiments leverages the confluence of information including inferred team strategies, inferred players' roles and features, as well as domain knowledge, in order to predict which are the key players and what are their respective future action sequences. Given the inferred team strategy up to the current frame, K, (obtained from the inference problem), a scene change point is defined as a frame index t such that

$$S ( τ ) \neq S ( τ + 1 ) , τ = 1 , … , κ - 1 \qquad ( 4 )$$

and is typically unknown a priori. Let τ=[τ₁ . . . τₘ]^{T} represent the scene change points up to the current time K, where τ₁=1 and τₘ≤κ. Video frames between every two consecutive scene change points have the same inferred team strategy and, therefore, can be automatically grouped as a scene segment, which eliminates the algorithm's dependence on pre-trimmed videos. Let Vₗ, l=1, . . . , m denote the lth scene segment with the frame-index set Tₗ defined as

$${T}_{l} = \{ \begin{matrix}\{ {τ}_{l} , … , {τ}_{l + 1} - 1 \} & l = 1 , … , m - 1 \\ \{ {τ}_{l} , … , κ \} & l = m\end{matrix} \qquad ( 5 )$$

Consequently, Vₗ can be represented as

$${V}_{l} = \{ I ( k ) \vert k ∈ {T}_{l} \} , l = 1 , … , m . \qquad ( 6 )$$

The duration of Vₗ, denoted by dₗ, equals the number of frames in Tₗ multiplied by the discrete-time sampling interval Δt.

$${d}_{l} = \{ \begin{matrix}( {τ}_{l + 1} - {τ}_{l} ) Δ t & l = 1 , … , m - 1 \\ \{ κ - {τ}_{l} + 1 ) Δ t & l = m\end{matrix} \qquad ( 7 )$$

After defining the scene segments, variables that are defined in each frame I(k) can be upgraded to represent the whole segment, as shown in Table 1 below, where the argument in “( )” represents the frame index, the subscript “i” represents the player index, and the subscript “l” represents the segment index.

TABLE 1
Notation of Frame Variables and Segment Variables

| Frame variable | Description | Segment variable | Description |
|---|---|---|---|
| S(k) | Team strategy in frame I(k) | Sₗ = {S(k) \| k ∈ Tₗ} | Team strategy in segment Vₗ |
| Aᵢ(k) | Action of player i in frame I(k) | A_{i, l} = {Aᵢ(k) \| k ∈ Tₗ} | Action of player i in segment Vₗ |
| Xᵢ(k) | Role of player i in frame I(k) | X_{i, l} = {Xᵢ(k) \| k ∈ Tₗ} | Role of player i in segment Vₗ |
| pᵢ(k) | 2D location of player i in frame I(k) | P_{i, l} = {pᵢ(k) \| k ∈ Tₗ} | 2D location of player i in segment Vₗ |

In order to distinguish a small set of players who will perform dominant actions that influence the game progress, a binary indicator variable μᵢ(κ)∈{0,1} is introduced for a player i such that its value equals one if the corresponding player will become a key player, and equals zero otherwise. μᵢ(κ) can be obtained by constructing a mapping, f_{μ}: [symbol] × [symbol] →{0,1}, that takes as input the inferred team strategy label S(k)) and role label Xᵢ(k) and outputs the binary indicator value

$${μ}_{i} ( κ ) = {f}_{μ} ( S ( k ) , {X}_{i} ( k ) ) , \qquad ( 8 )$$

where f_{μ}(⋅) can be learned as a binary classifier based on a small amount of annotated data, or it can be derived using domain knowledge about the likelihood of a player being the key player given the corresponding role and team strategy. The complete set of predicted key players is

$$𝒦 = \{ i \vert {μ}_{i} ( κ ) = 1 , i ∈ 𝒩 \} \qquad ( 9 )$$

Action anticipation of a key player considers four types of information collected in the current scene segment Vₘ, i.e., the inferred team strategy Sₘ, the inferred role X_{i,m}, the ongoing action A_{i,m} and the player's 2D spatial location P_{i,m}. Furthermore, the Markov assumption is adopted such that future action A_{i,m+1} is independent from past action A_{i,m-1} with given {A_{i,m}, P_{i,m}, X_{i,m}, Sₘ}, i∈ [symbol] . The Markov assumption is justifiable because the hybrid inputs encode information from multiple sources, hence enriching the model and reducing the dependence of future action on historical data. By virtue of such an assumption, action anticipation can utilize a short-term input with arbitrary starting scenes. Finally, the action anticipation problem can be summarized as follows: Given the inferred team strategy label S(κ) and role label X(κ) of the current frame I(κ)∈Vₘ, predict the set of key players, [symbol] ⊆ [symbol] , using (8-9). Then, for each key player i∈ [symbol] , predict the semantic label, onset and duration of their future actions A_{i,m+1} using aggregated input sequences {A_{i,m}, P_{i,m}, X_{i,m}, Sₘ}.

### Inference Model

An example inference model used in illustrative embodiments will now be described in detail. Inferring team strategy in some embodiments utilizes a multi-class classifier to map the feature vector F(k) to a label S(k) that represents the technical team activity in each frame. Some embodiments disclosed herein use an MLP to perform the task, although it is to be appreciated that other classifiers, such as random forest classifiers, are also applicable. The inferred team strategy label, S(k), is appended to the feature vector of the ith player to form an augmented feature vector, i.e., Zᵢ(k)=[Fᵢ(k)^{T} S(k)]^{T}, i∈ [symbol] , which can then be organized into an augmented feature matrix for all players

$$Z ( k ) = [ {Z}_{i} ( k ) … {Z}_{N} ( k ) ] \qquad ( 10 )$$

Some embodiments implement the inference model as a Markov Random Field (MRF) model of team player roles and interactions, and more particularly as a dynamic MRF (DMRF) model. More particularly, an example DMRF model with dynamical graph structures as described below is utilized to infer the joint probability of players' roles X(k) from the augmented feature matrix Z(k).

Classic MRFs are probabilistic models comprising an undirected graph with a set of nodes that each represent correlated random variables, and a set of undirected arcs (i.e., graph structure) that represents a factorization of the joint MRF probability learned from data. The advantages of MRFs over other probabilistic models include that MRFs can model processes with both hidden and observable variables, as well as include both categorical and continuous variables by describing different types of relationships using unary and pairwise potentials. MRFs have been widely used in computer vision problems such as image segmentation, image denoising, and image reconstruction. While in classic MRFs, the graph structure is fixed and decided a priori, illustrative embodiments herein provide an approach for constructing representations of the visual scene using DRMFs. For example, illustrative embodiments learn a temporally evolving graph structure from each frame for the inference of hidden role variables, where only the set of nodes remains unchanged, and the arcs appear or disappear from frame to frame based on the events in the scene.

In this approach, every hidden node, denoted by Xᵢ(k) (i∈ [symbol] ), represents the hidden role of player i, and every observable node, denoted by Zᵢ(k) (i∈ [symbol] ), represents the feature vector of player i. The temporally evolving arc set, ε(k), is then learned from the players' relative distance by minimizing an energy function such that the minimum value corresponds to the optimal arc configuration. In order to infer the players' roles from all available information, each node Xᵢ(k) is connected to the corresponding feature vector Zᵢ(k). Xᵢ(k) is associated with a unary potential φ(Xᵢ(k), Zᵢ(k)) that captures how probable feature Zᵢ(k) is for different realizations of Xᵢ(k).

Every arc is associated with a pairwise potential ψ(Xᵢ(k), Xⱼ(k)) that represents the strength of correlations between the two random variables Xᵢ(k) and Xⱼ(k) in a spatial neighborhood. Then, the joint probability distribution of the random variables can be factorized as the product of potential functions over the graph structure

$$P ( X ( k ) \vert Z ( k ) , ε ( k ) ) = \frac{1}{C} {\prod }_{i ∈ 𝒩} ϕ ( {X}_{i} ( k ) , {Z}_{i} ( k ) ) {\prod }_{i , j ∈ ε ( k )} ψ ( {X}_{i} ( k ) , {X}_{j} ( k ) ) \qquad ( 11 )$$

where C is the partition function that guarantees P(X(k)|Z(k)) is a valid distribution and the scope of pairwise potentials is determined by the estimated graph structure ε(k).

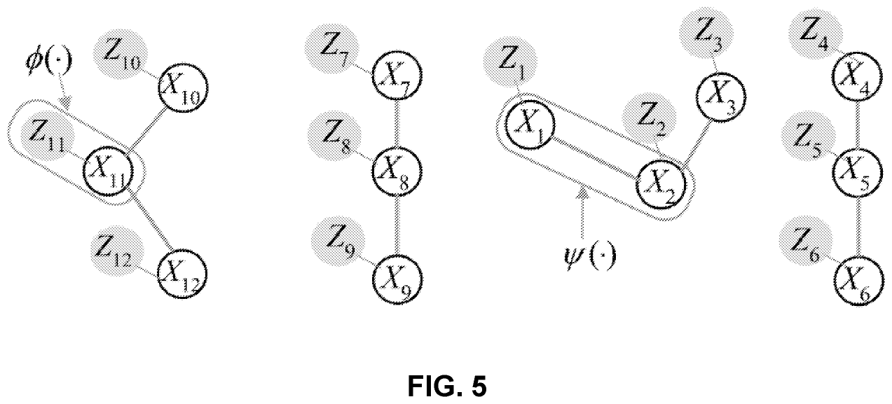

FIG. 5 shows an example DMRF model for player role inference, where the time argument k is omitted for brevity. The potential functions in this example DMRF model are learned in the manner described below.

The unary potential φᵢ(Xᵢ(k), Zᵢ(k)) expresses how probable the feature vector Zᵢ(k) is for different realization of the role label Xᵢ(k), and can be modeled as a likelihood function

$${ϕ}_{i} ( {X}_{i} ( k ) , {Z}_{i} ( k ) ) {=}^{Δ} P ( {Z}_{i} ( k ) \vert {X}_{i} ( k ) ) . \qquad ( 12 )$$

Let [symbol] ={1, 2, . . . , R} denote the set of role labels such that Xᵢ(k)=n(n∈ [symbol] ) if player i assumes the nth semantic role label. Let 1ₙ∈{0,1}^{R} be a R-dimensional one-hot vector where the nth entry equals one and the rest of the entries each equal zero. The likelihood function can be defined as

$$P ( {Z}_{i} ( k ) \vert {X}_{i} ( k ) = n ) = \frac{exp \{ {1}_{n}^{T} \cdot [ {W}_{u 2} \cdot σ ( {W}_{u 1} \cdot {Z}_{i} ( k ) ) ] \}}{{\sum }_{m = 1}^{R} exp \{ {1}_{m}^{T} \cdot [ {W}_{u 2} \cdot σ ( {W}_{u 2} \cdot {Z}_{i} ( k ) ) ] \}} \qquad ( 13 )$$

where σ(Ω) is the sigmoid function, Wᵤ₁ and Wᵤ₂ are weights that will be learned from data and their dimensions are hyper-parameters selected to agree with the dot product.

Pairwise potential concerns the interrelationship between two node variables taking particular roles, with greater value indicating higher probability for the corresponding players to interact in a team. For instance, the pair “setter-hitter” has a higher chance to interact in a close proximity than “setter-blocker” pair since the latter only appears in two opposing teams. Let Wₚ∈ [symbol] ^{R×R} denote the weight matrix that represents the correlation between a pair of roles. Then, the pairwise potential is defined as

$$ψ ( {X}_{i} ( k ) = n , {X}_{j} ( k ) = m ) {=}^{Δ} {1}_{n}^{T} \cdot {W}_{p} \cdot {1}_{m} . \qquad ( 14 )$$

The graph structure, ε(k), determines the scope of pairwise potentials. Traditionally, the MRF graph structure is established a priori and remains fixed. Illustrative embodiments overcome this limitation of conventional practice by providing an advantageous DMRF approach configured to learn and adapt the graph structure online based on streaming video frames. In this example approach, the graph structure can vary from an empty arc set to a fully connected (FC) configuration.

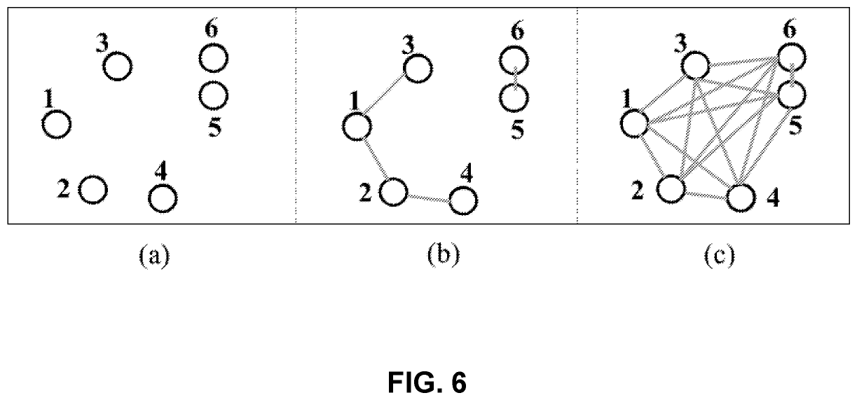

FIG. 6 shows an example graphical model with an empty arc set, a sparse arc set and a dense arc set in an illustrative embodiment, in respective parts (a), (b) and (c) of the figure. In this simplified example, there are six nodes, labelled 1 through 6 in the figure, although other embodiments can include more or fewer nodes.

An empty arc set, illustrated in part (a) of FIG. 6, indicates that all nodes (e.g., players' roles) are independent and there are no interactions between them. Conversely, a densely connected configuration, such as that shown in part (c) of FIG. 6, captures many interrelationships, including redundant ones and, thus, may incur unnecessary computational burden. An example approach provided in illustrative embodiments herein produces an efficient structure estimation algorithm, described in more detail below, to dynamically estimate a sparse structure, such as that shown in part (b) of FIG. 6, that advantageously captures the most significant interactions in each video frame.

Let Y_{i,j}(k) denote a binary variable such that its value y_{i,j}(k) equals one when an interaction arc exists between players labeled by i and j, and equals zero otherwise. Then the arc set can be denoted as ε(k)={(i,j)|y_{i,j}(k)=1, i, j ∈ [symbol] }, and the structure estimation problem can be cast as a constrained optimization problem over the arc variables Y_{i,j}(k). In many human team activities, such as sports, proximity is an indication of potential interactions and, therefore, in some embodiments, the DMRF graph structure is indicative of interrelationships between spatial neighbors. Other representations are also possible, depending on the application, and may be adopted in illustrative embodiments with small modifications. Then, the Euclidean distance d_{i,j}(k)=∥pᵢ(k)−pⱼ(k)∥ between every pair of players is used to construct an energy function that is linear in the realizations of the arc variables Y_{i,j}(k),

$$E ( Z ( k ) , ε ( k ) ) {=}^{Δ} {\sum }_{( i , j ) ∈ ε ( k )} {d}_{i , j} ( k ) {y}_{i , j} ( k ) \qquad ( 15 )$$

such that the optimal arc configuration corresponds to the minimum of the energy function. Subsequently, minimizing the energy function can be implemented by solving an Integer Linear Program, illustratively configured as follows:

$$\begin{matrix}\begin{matrix}min \\ ε ( k )\end{matrix} {\sum }_{( i , j ) ∈ ε ( k )} {d}_{i , j} ( k ) {y}_{i , j} ( k ) \\ subject to\end{matrix} \qquad ( 16 )$$

$${y}_{i , j} ( k ) = {y}_{j , i} ( k ) , ∀ ( i , j ) ∈ ε ( k ) \qquad ( 17 )$$

$${\sum }_{i , ∈ 𝒩} {y}_{i , j} ( k ) \geq 1 , ∀ j ∈ 𝒩 \qquad ( 18 )$$

$${\sum }_{i , ∈ 𝒩} {y}_{i , j} ( k ) \leq 2 , ∀ j ∈ 𝒩 \qquad ( 19 )$$

$${y}_{i , j} ( k ) ∈ \{ 0 , 1 \} ∀ ( i , j ) ∈ ε ( k ) \qquad ( 20 )$$

The constraint in (17) guarantees that interactions are symmetric, and (18)-(19) specify that a node has a minimum of one and maximum of two arcs connecting to its spatial neighbors, resulting in a sparse structure. Although only the proximity feature is considered, the example method above provides a generic algorithm that can incorporate other features to estimate social interactions. Additional examples regarding estimating interactions can be found in, for example, Junyi Dong et al., “Oriented Pedestrian Social Interaction Modeling and Inference,” In Proceedings of the 2020 American Control Conference, IEEE, pp. 1373-1380 Jul. 1-3, 2020, which is incorporated by reference herein in its entirety. After ε(k) is estimated, the joint probability distribution of the role variables in (11) is factorized as the product of potential functions over ε(k).

An example spatio-temporal MRF model based on the foregoing will now be described in more detail. In the following, an approach is provided for reconstructing the temporal evolution of random variables X(k) across frames to recursively estimate the joint role labeling using a sequence of feature vectors and the DMRF model of a single frame derived in (11). Let γ(Xᵢ(k−1), Xᵢ(k)) denote the temporal potential function that measures the compatibility of temporal transitions between Xᵢ(k−1) and Xᵢ(k). The temporal potential function can be modeled by a transition matrix Wₜ∈ [symbol] ^{R×R} such that

$$γ ( {X}_{i} ( k - 1 ) = n , {X}_{i} ( k ) = m ) {=}^{Δ} {1}_{n}^{T} \cdot {W}_{t} \cdot {1}_{m} . \qquad ( 21 )$$

The temporal potential function can be integrated with the pairwise potential function to construct a joint state transition function

$$P ( X ( k ) \vert X ( k - 1 ) ) ∝ {\prod }_{i ∈ 𝒩} γ ( {X}_{i} ( k - 1 ) , {X}_{i} ( k ) ) {\prod }_{i , j ∈ ε ( k )} ψ ( {X}_{i} ( k ) , {X}_{j} ( k ) ) \qquad ( 22 )$$

On the other hand, the product of unary potentials can be treated as the joint likelihood function, assuming that individual features are conditionally independent given the realization of random variables

$$P ( Z ( k ) \vert X ( k ) ) = {\prod }_{i ∈ 𝒩} P ( {Z}_{i} ( k ) \vert {X}_{i} ( k ) ) {\prod }_{i ∈ 𝒩} ϕ ( {X}_{i} ( k ) , {Z}_{i} ( k ) ) \qquad ( 23 )$$

Let Z(1, k)={Z(l)|1≤l≤k} denote a sequence of extracted feature vectors obtained from an initial frame (l=1) up to the kth frame. Then, the joint probability of X(k) can be recursively estimated from Z(1, k) in a fashion similar to Bayesian filtering

$$P ( X ( k ) \vert Z ( 1 , k ) ) = \frac{1}{C} P ( Z ( k ) \vert X ( k ) ) {\sum }_{X ( k - 1 )} P ( X ( k ) \vert X ( k - 1 ) ) P ( X ( k - 1 ) \vert Z ( 1 , k - 1 ) ) \qquad ( 24 )$$

where Ĉ is the partition function that guarantees P(X(k)|Z(1, k)) is a valid distribution.

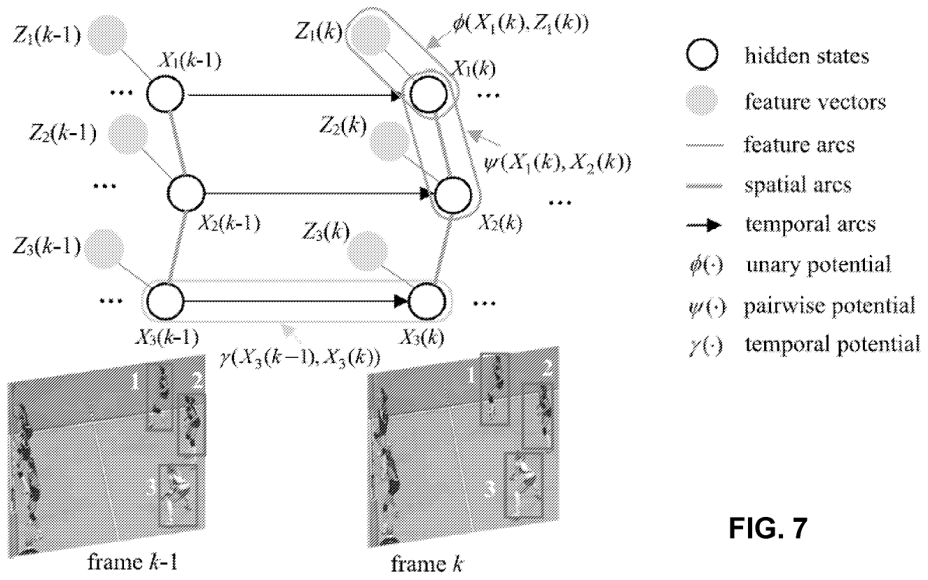

FIG. 7 shows an example of a spatio-temporal MRF model of the type described above, for modeling player roles in an illustrative embodiment. A challenge arises in such an embodiment because P(X(k)|Z(1, k)) is a multi-dimensional joint distribution that has significant computational ramifications. In order to keep the computation tractable in illustrative embodiments, the joint distribution is achieved via an MCMC sampling method by constructing a set of random samples that constitute a Markov chain whose stationary distribution converges to the desired distribution.

The MRF model is trained in an incremental manner in which the parameters of unary potentials are first trained and then fixed to learn the pairwise potentials. This incremental training allows the pairwise potentials to be built upon strong unary potentials, which makes the training more efficient because otherwise the pairwise potentials may not be able to capture the significant interactions from misleading unary potentials. In particular, the unary potential is trained by minimizing the cross-entropy loss function, whereas the pairwise potential can be learned using the structural support vector machine (SVM) framework or using domain knowledge about the relationship between different roles. This two-stage learning is performed in a frame-wise manner by leaving out the temporal transition matrix, which is fine-tuned at last on the training database. This incremental training allows the model to learn specific information presented in each potential function and reduces the computational burden that would otherwise be incurred if all potential functions are learned together.

As indicated above, inferring a role labeling X(k) from the joint distribution P(X(k)|Z(1, k)) suffers from an enormous combinatorial complexity. Naively searching through the set of all possible labeling is intractable because the set has a cardinality that is exponential in the number of states. Illustrative embodiments herein therefore utilize an MCMC sampling method to address the computational ramifications, which generates a Markov chain over the space of the joint configuration X(k), such that the chain has a stationary distribution converging to P(X(k)|Z(1, k)). Assume the posterior P(X(k−1)|Z(1, k−1)) at time k−1 is represented by a set of Nₛ∈ [symbol] ⁺ samples

$${\{ {X ( k - 1 )}^{( l )} \}}_{l = 1}^{N} ,$$

and each sample corresponds to a joint role labeling of all players, i.e., X(k−1)^{(l)}=[X₁(k−1)^{(l)} . . . X_{N}(k−1)^{(l)}]^{T}. Then, the Monte Carlo approximation to the posterior distribution in (24) at time k is

$$P ( X ( k ) \vert Z ( 1 , k ) ) \approx \frac{1}{\hat{C}} P ( Z ( k ) \vert X ( k ) ) {\sum }_{l = 1}^{{N}_{s}} P ( X ( k ) \vert {X ( k - 1 )}^{( l )} ) \qquad ( 25 )$$

Substituting (22)-(23) into (25) gives

$$\begin{matrix}P ( X ( k ) \vert Z ( 1 , k ) ) \approx \\ \frac{1}{\hat{C}} {\prod }_{i ∈ 𝒩} ϕ ( {X}_{i} ( k ) , {Z}_{i} ( k ) ) {\prod }_{i , j ∈ ε ( k )} ψ ( {X}_{i} ( k ) , {X}_{j} ( k ) ) {\sum }_{l}^{{N}_{s}} {\prod }_{i} γ ( {{X}_{i} ( k - 1 )}^{( l )} , {X}_{i} ( k ) )\end{matrix}$$

resulting in a sample-based representation for the distribution

$$P ( X ( k ) \vert Z ( 1 , k ) ) \approx {\{ {X ( k )}^{( l )} \}}_{t = 1}^{{N}_{s}} .$$

The Metropolis-Hastings (MH) algorithm with the symmetric random walk proposal distribution is implemented for simulating the Markov chain.

### Anticipation Model

In some embodiments, action anticipation predicts a set of key players and their future actions as time evolves. Conventional methods cannot be easily adapted to the action anticipation problem because they do not take into account the time varying team strategy and players' roles, which are core to team actions. The anticipation model provided in illustrative embodiments herein aggregates inferred hidden variables (inferred team strategy and players' roles) with explicit visual features, forming a rich input representation. The prediction of key players, [symbol] ⊂ [symbol] , is first achieved via (8)-(9). Subsequently, for each predicted key player, i∈ [symbol] , the action anticipation model merges four types of information corresponding to the current scene segment, i.e., {Sₘ, X_{i,m}, A_{i,m}, P_{i,m}}, to anticipate the future action A_{i,m+1}.

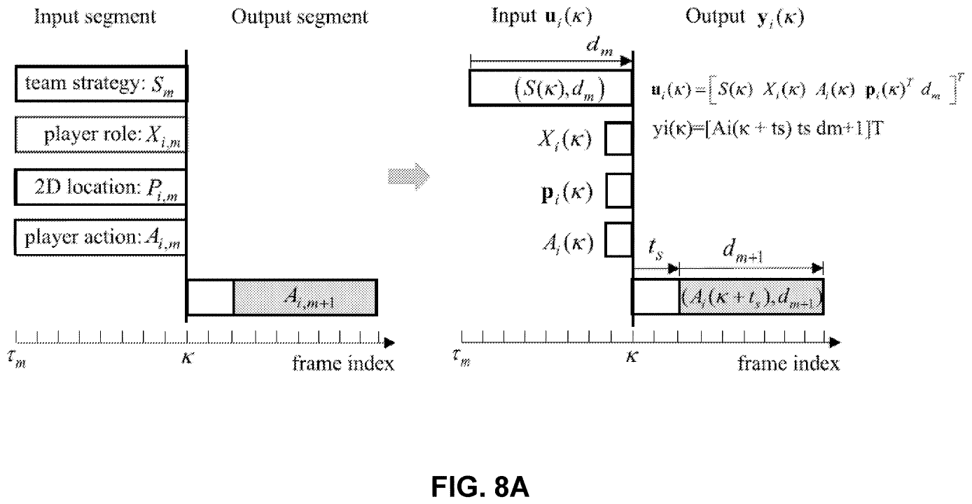

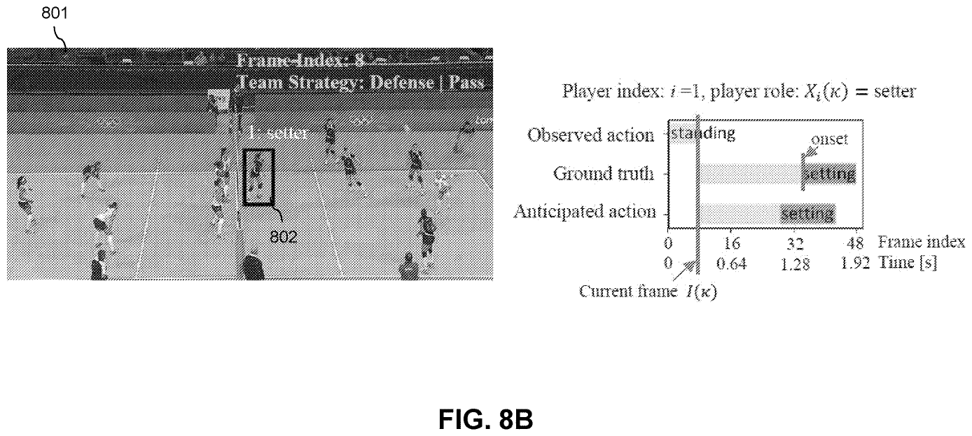

FIG. 8A shows example input and output segments and a corresponding simplified instantaneous representation for action anticipation of a key player in an illustrative embodiment. The left side of the figure shows the input and output segments for action anticipation of the ith key player, and the right side of the figure shows the corresponding simplified instantaneous representation.

The representation of input segments directly affects the learning efficiency and computational cost of the model. Thus, it is worth exploring a compact representation of {Sₘ, X_{i,m}, A_{i,m}, P_{i,m}}. Based on the definition of the scene change point and scene segment in (4)-(6), the segment variable of team strategy, Sₘ, takes a constant value within the scene segment Vₘ. Hence, Sₘ can be fully defined by its value at the current time, K, and the duration of Vₘ up to κ, that is, Sₘ≙(S (κ), dₘ). Although values of X_{i,m}, A_{i,m}, and P_{i,m} can vary within a scene segment, it is observed that future actions are most closely related to their respective values at the current time K. Furthermore, some embodiments provide a frame-wise representation of the anticipation input and output, such that they can be updated instantaneously as time unfolds. As a result, only Aᵢ(κ), Xᵢ(κ), and pᵢ(κ) are preserved as inputs, as illustrated in FIG. 8A. These inputs, together with (S(κ), dₘ), constitute an input vector

$${u}_{i} ( κ ) = {[ S ( κ ) {X}_{i} ( κ ) {A}_{i} ( κ ) {{p}_{i} ( κ )}^{T} {d}_{m} ]}^{T} \qquad ( 27 )$$

where the time-varying characteristic of dₘ represents the variable duration of the team strategy S(κ). Likewise, the anticipation output, A_{i,m}+1, is designed to have an instantaneous representation of the future actions. Let tₛ denote the time to onset, that is, the amount of time until the onset of A_{i,m+1}, and let dₘ₊₁ denote the duration of A_{i,m+1}. Then, A_{i,m+1} can be defined as A_{i,m+1}≙(Aᵢ(κ+tₛ), dₘ₊₁), as shown at the right side of FIG. 8A. Equivalently, A_{i,m+1} can be specified by a vector representation comprising three unknown variables

$${y}_{i} ( κ ) = {[ {A}_{i} ( κ + {t}_{s} ) {t}_{s} {d}_{m + 1} ]}^{T} \qquad ( 28 )$$

It follows from (27)-(28) that the action anticipation task in illustrative embodiments predicts yᵢ(κ) based on uᵢ(κ) as time evolves.

FIG. 8B shows an example of an anticipated action for a key player in a particular video frame 801 of a sequence of video frames in a video signal. The frame rate in this example is 25 frames per second (fps). The key player is shown in a bounding box 802 in the video frame 801 at the left side of the figure. As illustrated there, the setter marked by the bounding box 802 is predicted as the key player who will dominate the game based on the inferred role and team strategy. The observed action, the ground truth future action, and the anticipated action are illustrated in the bar chart on the right side of the figure. The long vertical line in the bar chart indicates where the current frame is temporally located in the sequence of video frames. Each of the first segments of the middle bar and the bottom bar have the same shading as the top bar, representing that the current action would continue until the onset of the future action which is shown with a different shading.

It can be seen from FIG. 8B that the anticipation stage in this example provides a credible prediction of the action of the key player who will be setting the ball, in spite of the discrepancy of 7 frames (0.28 seconds) between the predicted timing and ground truth, as shown in the length of the middle and bottom bars.

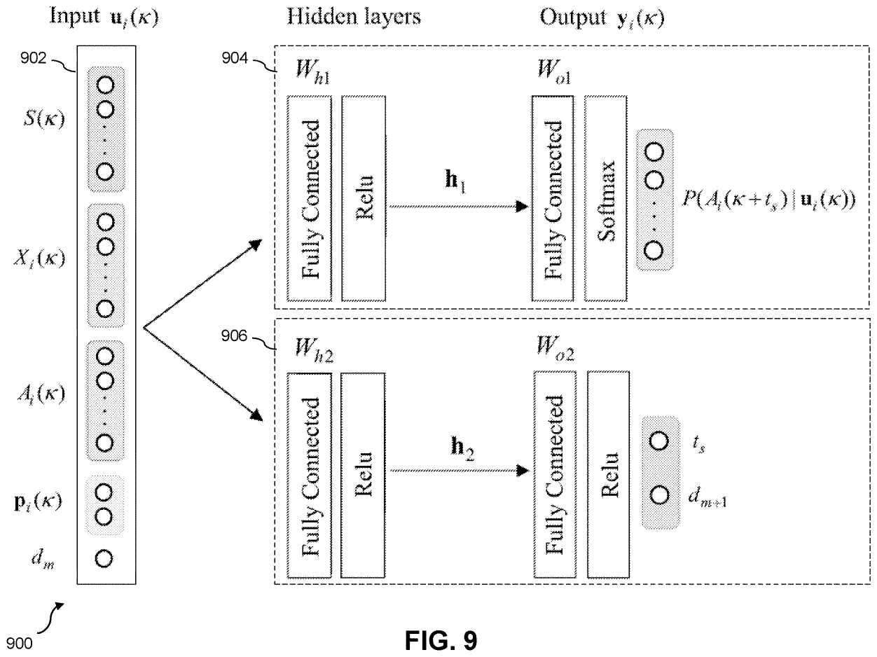

FIG. 9 shows an example neural network 900 comprising a multi-layer perceptron (MLP) for action anticipation in an illustrative embodiment.

The MLP receives input vector 902 and is configured to perform the action anticipation task based on the example input-output representation in (27)-(28). Categorical variables in uᵢ(κ) are converted to binary representations via one-hot encoding. The encoded uᵢ(κ) is passed through two branches, including an upper branch 904 and a lower branch 906 as shown in FIG. 9, where the upper branch 904 is configured to output a probability distribution for the discrete variable Aᵢ(κ+tₛ) and the lower branch 906 generates two positive scalar values for the continuous variables, tₛ and dₘ₊₁, respectively. In particular, the upper branch 904 first maps the input vector 902 to a latent vector, h₁, using a FC layer followed by the rectified linear unit (“relu”) activation function

$${h}_{1} = rehu ( {W}_{h 1} {u}_{i} ( κ ) ) \qquad ( 29 )$$

where Wₕ₁ is the weight matrix. Subsequently, h₁ is fed to the output layer, composed of a FC layer and the softmax activation function, to generate the conditional probability distribution of P(Aᵢ(κ+tₛ)|uᵢ(κ)).

Let [symbol] ={1, 2, . . . , A} denote the range of the action classes, where each integer, a∈ [symbol] , represents a semantic action label, and Wₒ₁=[w₁ . . . . W_{A}]^{T} denote the weight matrix of the output FC layer. Then, P(Aᵢ(κ+tₛ)=a|uᵢ(κ) is computed as

$$P ( {A}_{i} ( κ + {t}_{s} ) = a \vert {u}_{i} ( κ ) ) = \frac{exp ( {w}_{a}^{T} {h}_{1} )}{{\sum }_{{a}^{′} = 1}^{A} exp ( {w}_{{a}^{′} ′}^{T} {h}_{1} )} , a ∈ 𝒜 \qquad ( 30 )$$

and the action class with the highest probability is chosen as the anticipated action. Although the lower branch 906 adopts the same structure as the upper branch 904, the FC layers can have different dimensions and the output activation function is designed to be a relu activation function for guaranteeing real positive values of tₛ and dₘ₊₁. Let Wₕ₂ denote the weights of the hidden FC layer in the lower branch 906, and Wₒ₂=[w_{τ} w_{d}]^{T} denote the weights of the corresponding output FC layer. Then, tₛ and dₘ₊₁ are obtained as follows:

$$\begin{matrix}{h}_{2} = relu ( {W}_{h 2} {u}_{i} ( κ ) ) \\ {t}_{s} = relu ( {w}_{τ}^{T} {h}_{2} ) \\ {d}_{m + 1} = relu ( {w}_{d}^{T} {h}_{2} )\end{matrix} \qquad ( 31 )$$

The complete set of the MLP parameters, Θ_{A}={Wₕ₁, Wₕ₂, Wₒ₁, Wₒ₂}, is trained by minimizing an anticipation loss that is a function of the ground truth and the actual predicted output. In particular, the loss function is formulated as the summation of the cross-entropy loss of the discrete action variable, Aᵢ(κ+tₛ), and the mean squared loss of the two timing variables, tₛ and dₘ₊₁.

In illustrative embodiments, the input-output representation in (27)-(28) allows the input to be updated in each frame and the anticipation output to progressively change as more observations stream in. Furthermore, the trained model is shared across all players, and, therefore, anticipation for multiple players can be performed simultaneously by constructing an input vector for each of them.

### EXPERIMENTS

Experiments were conducted in order to validate the accuracy of illustrative embodiments. Using an existing volleyball activity dataset, a supervised training database for example inference and anticipation algorithms was obtained by annotating team strategies, player roles, player actions, and other visual and positional information. Despite additional supervision utilized for learning the intermediate hidden variables, the overall labeling effort is less than that required by deep neural network models for action anticipation trained solely on images. The reason is that the illustrative embodiments exploit the problem structure and incorporate domain knowledge before training the DMRF and MLP models. The inference and anticipation results were analyzed qualitatively and quantitatively on the testing data. The experiments conducted on illustrative embodiments disclosed herein are focused on evaluating the overall performance of the inference and anticipation models. Moreover, comparative studies that involve three types of experiments were carried out to determine the anticipation performance variability as a function of the hidden variables and corresponding inference accuracy.

The DMRF inference results were determined for a sample sequence of frames extracted from a testing video clip, where the inferred team strategies and players' roles evolve over time. In these results, evolution of the inferred team strategy from “attack | block” to “defense | pass” to “defense | set” and the players' roles were inferred in each frame. It should be noted that a team strategy spans over several consecutive frames, during which the action and spatial layout of players may be shifted, but not qualified to be inferred as a different category. The DMRF model described previously correctly infers that the team strategy changes from “attack | block” to “defense | pass” to “defense | set,” exemplifying the algorithm's robustness to the dynamically evolving scenes. Similarly, the players' roles change as the game unfolds. For example, the role of one player alters from “right-hitter” to “blocker,” whereas another player, originally a “blocker,” becomes a “left-hitter.” It was found that inference failures are more likely to happen when players are shifting to new locations. However, as more observations are received, the updated inference results would be self-corrected and thus match the ground truth. It should be noted that this kind of error is inevitable, even for human experts who identify players' roles in a transitioning process without further information such as a player's name or jersey number, and such further information can be utilized in other embodiments.

Action anticipation is performed using inferred team strategy and players roles, in accordance with experiments to be described in more detail below. Anticipation results were determined for two testing video clips with a framerate of 25 frames per second (fps). A portion of these results were previously described in conjunction with the example of FIG. 8B, in which the setter is predicted as the key player who will dominate the game based on the inferred role and team strategy. The anticipation MLP in the FIG. 8B example gives the credible prediction of the key player who will be setting the ball, in spite of the discrepancy of 7 frames (0.28 seconds) between the predicted timing and ground truth. Moreover, as time evolves over multiple frames, the difference in timing gradually reduces, indicating the update of anticipation result as the future unfolds.

On the other hand, multiple individuals can be predicted as key players. Based on a short observation sequence of 7 frames (0.28 seconds), the anticipation MLP predicts that both middle-hitter and left-hitter will launch a spiking, although the ground truth shows only the left-hitter eventually spikes the ball. Such mistake or conservatism is inevitable because it is yet uncertain in this moment who would launch the final attack as they both have great opportunity. This is also a general tactic when one of the hitters potentially makes a feint in order to distract blockers of the opposing team. As the game proceeds, the anticipated action of the middle-hitter evolves, finally reaching to the ground truth.

The effectiveness of the inference and action anticipation algorithms as described above is demonstrated using the metrics known as multi-class average precision (APr), multi-class average recall (ARc), and multi-class average accuracy (Ac). The APr score concerns the proportion of inferred values, including both true positive (TP) and false positive (FP), that are actually true (i.e., APr=TP/(TP+FP)). In contrast, the ARc score is the proportion of ground truth labels, including both TP and false negative (FN), that are correctly inferred (i.e., ARc=TP/(TP+FN)). For both metrics, higher values correspond to better performance. Finally, Ac is defined as the harmonic mean of APr and ARc, which is also known as the F1-score

$$Ac = 2 \frac{APr \times ARc}{APr + ARc} \qquad ( 32 )$$

Two hidden variables, the team strategy (S(κ)) and the players' roles (X(κ)), are inferred in each frame with the overall results presented in Table 2 below. A comparative study is performed to assess the performance of the anticipation model as well as the robustness of the holistic framework, i.e., the dependence of the anticipating ability on the inferred hidden variables.

The comparative study involves three types of experiments aimed at determining the performance variability as a function of the hidden variables and corresponding inference accuracy:
Experiment 1: perfect knowledge of team strategy (S(κ)) and player roles (X(κ));
Experiment 2: inferred team strategy (S(κ)) and perfect knowledge of player roles (X(κ));
Experiment 3: inferred team strategy (S(κ)) and player roles (X(κ)).

The purpose of the first experiment is to determine the performance of the action anticipation independently of the inference algorithm. The results in Table 2 below show the important influence that the player role and team strategy have on the solution of the action anticipation problem. As a result, the action anticipation performance degrades as errors are introduced in the inference stage, through Experiments 2 and 3. This is because, despite the excellent performance of the DMRF algorithm as shown in Table 2, inferring the hidden variables from video introduces some errors (compared to perfect knowledge) that are, then, propagated to the action anticipation algorithm.

TABLE 2
Inference and Action Anticipation Performance

| | Average | Average | Average |
|---|---|---|---|
| Experiment | Precision | Recall | Accuracy |
| Team strategy inference | 0.87 | 0.82 | 84.43% |
| Role inference | 0.88 | 0.86 | 86.99% |
| Experiment 1 | 0.92 | 0.89 | 90.47% |
| Experiment 2 | 0.88 | 0.86 | 86.99% |
| Experiment 3 | 0.81 | 0.80 | 80.50% |

TABLE 3
Ablation Study Regarding the Hidden Role Variables

| Model | Average Precision | Average Recall | Average Accuracy |
|---|---|---|---|
| Experiment 3 | 0.81 | 0.80 | 80.50% |
| Experiment 4 | 0.71 | 0.69 | 69.99% |

An advantage of the holistic approach of illustrative embodiments is that action anticipation draws from the aggregation of both implicit hidden variables and explicit visual features. Therefore, errors from one source of information are potentially compensated by information obtained from other features. The performance results could be further improved by leveraging other variables and sensor modalities, which are easily incorporated in illustrative embodiments by augmenting the disclosed feature vectors. In addition, an ablation study is performed with a variant of the example model that excludes the inferred players' roles from the illustrative holistic framework shown in FIG. 2, using the following experiment:

Experiment 4: action anticipation without player roles (X(κ)) in the model input.

Table 3 above compares the results of Experiment 4 against the results of the example holistic approach of Experiment 3. Without the knowledge of players' roles, Experiment 4 sees a significant drop in the action anticipation accuracy, which, by contrast, shows the improvement brought by the inference of hidden role variables to the solution of the action anticipation problem.

In some embodiments, the ability to predict the onset and duration of a future action is also critical, as well as coupled with the problem of anticipating the action type, since many algorithms assume the starting time is known or even observed. Team sports offer an excellent benchmark problem, because players constantly adjust the timing and duration of their actions, speeding up or slowing down actions and behaviors for strategic purposes. These difficulties are exacerbated by varying contexts, for example, because the trajectory of the ball and the skills of the opponents differ greatly from one team to another, yielding different samples in the training and testing datasets. The performance of action timing prediction is evaluated by the time-relative error, which is defined as the ratio of the absolute prediction error to the corresponding prediction horizon. Then, the mean of the time-relative error (MTRE) of each testing instance is used as the metric to assess the performance on the test database. The example model achieves an MTRE of 14.57% and 15.67% for the prediction of the action onset and duration, respectively. The DMRF-MLP approach provided in illustrative embodiments herein achieves a prediction horizon of 0.48-1.84 seconds, using an observation time window of 0.12-1.80 seconds, and is thus well suited to use cases involving fast actions and highly dynamic activities, such as sports.

Some embodiments disclosed herein provide a holistic approach that integrates image recognition, state estimation, and inference of hidden variables for the challenging problem of action anticipation in human teams. This example approach is demonstrated herein for the team sport of volleyball, in which the team strategy and players' roles are unobservable and change significantly over time, but is much more broadly applicable. The team strategy is first inferred by constructing a team feature descriptor that aggregates domain knowledge of volleyball games and features of individual players. Sequentially, the players' roles, modeled probabilistically as the DMRF graph, can be inferred using a MCMC sampling method, in some embodiments. The dynamic graph structure that captures player interrelationships can be estimated by solving an integer linear program in each frame.

By leveraging holistic information about the scene, including inferred team strategy, players' roles, as well as domain knowledge and instantaneous visual features, the action anticipation MLP is able to predict the semantic label and timing of the future actions by multiple interacting key players on the team. The numerical experiments show that this novel approach achieves an average accuracy of 84.43% for team strategy inference, 86.99% for role inference, and 80.50% for action anticipation. Additionally, the action onset and duration are predicted with a mean time-relative error of 14.57% and 15.67%, respectively.

Some embodiments disclosed herein provide a generalized approach that includes role inference and action anticipation through the development and integration of a dynamic graphical model, for higher level scene inference, with a deep neural network approach for action anticipation.

In some embodiments, a dynamic graphical model is configured to map a set of continuous and/or discrete variables (e.g., features) to a discrete output (e.g., a set of hidden variables, such as non-observables in a visual scene). The graphical model in some embodiments utilizes an enhanced MRF arrangement to provide a dynamic model for inference, but it is to be appreciated that other embodiments can utilize additional or alternative machine learning arrangements involving, for example, MLPs, Bayesian networks (BNs), influence diagrams (IDs), recurrent neural networks (RNNs), long short-term memory (LSTM) networks, gated recurrent units (GRUs), and so on. Additional examples of graphical models and associated machine learning techniques that can be used in illustrative embodiments can be found in, for example, Michael I. Jordan, “Learning in Graphical Models,” First Edition, Bradford, 1998, which is incorporated by reference herein in its entirety.

In some embodiments, a graphical model is used to fuse sensor information, such as visual players' features (position, action label, jersey color) extracted using computer vision, with other sensor data obtained, for example, using tracking devices, wearable sensors, or biometric sensors to name a few. This multi-modal data and observable players' features are fed to the graphical model and used to infer hidden variables such as player's roles and performance, team strategy, or phase of play.

Additionally or alternatively, the hidden variables inferred by the graphical model are used to anticipate the key players' actions using a deep neural network, trained on past data, such as a recurrent MLP model. This is accomplished in some embodiments by taking as input observables such as the players' position and action labels, as well as non-observables, such as the inferred players' roles and the team strategy information. This action anticipation functionality can be generalized by, for example, including data from different sensor modalities as inputs as well as by using different anticipation models. For instance, other suitable input can range from the players' velocity, acceleration and body orientation to the ball's velocity and position relative to different players. Other machine learning techniques can be utilized in place of MLPs to learn from past game data, such as multi-class classification/prediction methods comprised of random forest, LSTM, GRUs, neural attention models, convolutional neural networks (CNNs) and/or other machine learning arrangements.

As is apparent from the foregoing, illustrative embodiments disclosed herein provide a framework that naturally allows fusion and integration of other sensor modalities (e.g., auditory, tracking devices) with visual features extracted using computer vision.

For example, some embodiments consider the positions and visual features of the players extracted from video frames using homography transformations, but the same or a similar approach can be utilized with tracking devices worn by players and, potentially, can further incorporate information captured from sensors on or otherwise involving the ball. Algorithms in illustrative embodiments can be extended to include auditory information, player trajectories, and health metrics to provide a more comprehensive interpretation of the sports scene.

As an example of the use of auditory information, acoustic intensity in a stadium or arena can be monitored to infer the occurrence of significant events, such as penalties or goals/scoring. Data from wearable sensors, such as biometrics or position and velocity recordings, as well as sensing devices installed on the court and/or the ball/puck can be utilized to provide an additional input to the graphical model that would be otherwise challenging to extract from video frames alone, due to poor resolution and/or occlusions. Potentially, recordings of sports commentators may also provide immediate information about the event and an insightful understanding and analysis of the game, which can be leveraged with speech recognition methods in illustrative embodiments herein to enhance the robustness and accuracy of the inference and anticipation algorithm, especially when visual information is compromised.

Additionally or alternatively, player trajectories (e.g., time histories of position and velocity) can be incorporated as inputs for inferring roles/strategies and anticipating key events and behaviors. Compared to single-step position data, such player trajectories comprise additional motion information and can be used to indicate future motion trends on the court. Similarly, when available, ball/puck trajectories are also useful for predicting the future actions of the players. Taking volleyball as an example, ball trajectories and the distance of the ball to the players can be used in the disclosed algorithms to determine which player on the team playing offense will spike the ball.

Health metrics such as heart rate, body temperature, and blood pressure can be monitored via lightweight wearable devices, and utilized in inference and anticipation algorithms disclosed herein. Such wearable devices provide rich information on the physical condition of the players, such as tiredness, and can be used to help improve athletic performance. For example, in some embodiments, an algorithm as disclosed herein is configured to determine the physical state of the players and model the physical state as a hidden variable, in order to more accurately anticipate the next actions.

Example inference and anticipation frameworks as disclosed herein can be applied to other sports such as ice hockey for predicting the players' future trajectories and anticipating key players' actions based at least in part on multi-modal sensor data. Because ice hockey movements are very fast, tracking devices can be combined with video data to significantly improve performance in extracting accurate player and puck trajectories (e.g., heading, position, velocity, and acceleration). Ice hockey actions, such as “shoot” and “pass,” are combined with player trajectories to provide robust action recognition algorithms to detect their motion, using the techniques disclosed herein. Therefore, action anticipation for ice hockey (and potentially other sports like American football, soccer, and basketball) in illustrative embodiments herein are advantageously configured to leverage player action and trajectory information obtained from multiple sensor modalities, as well as new computer vision algorithms for automating player tracking and data association in the presence of occlusions, by leveraging dynamic models in the form of Markov motion models or other closed form representations such as ordinary differential equations.

Illustrative embodiments for action anticipation can be applied to formation design, player drafting and performance evaluation, in the context of team optimization, as will be described in more detail below.

With regard to formation design, team formation is an important part of team-level strategy and one of the most important tasks for team directors as every formation has strength and weakness in its strategy. Example algorithms disclosed herein can predict player action in game context, which can be used to determine an optimal team formation that will facilitate shot chances and increase win rate.

With regard to player draft, one of the most important problems in the front office of a professional sports team is scouting a new player who can fit the current squad and maximize the team performance. This is not only important for the performance of the sports team itself but also important in terms of business profitability, as drafting a novice player who can best fit the team can minimize the expenditure while maximizing the profit by improving the team performance. Example algorithms as disclosed herein can be applied to evaluate player creativity by comparing the predicted actions to the actual actions executed by the players. Frequent deviations between these two could suggest a high level of player creativity and flexible in-game decision-making ability. These soft skills are not captured from typical conventional statistics which only record high-level outcomes.

As indicated previously, evaluating player performance is an important aspect of roster building. The example algorithms in illustrative embodiments disclosed herein can be applied to determine significant events in a game, such as a scoring streak, to facilitate analysis by coaches. Moreover, anticipating and analyzing the player's role and action in these special scenarios is often more important than in common scenarios. In-game statistics usually do not differentiate between such scenarios, and the disclosed algorithms can be used to help understand player performance in a way that ordinary statistics cannot.

In some embodiments, action anticipation outputs of information processing systems as disclosed herein can be utilized to automatically populate one or more performance data structures for at least one of a group activity and an individual activity, such as a team activity and/or a player activity, in order to facilitate the above-described functionality for formation design, player drafting and performance evaluation.

For example, such data structures can be utilized to implement additional functionality such as generating one or more team formation recommendations based at least in part on predicted future actions, and/or quantifying values of one or more players of a sports team based at least in part on the one or more future actions.

In some embodiments, action anticipation for applications such as formation design, player drafting and performance evaluation is implemented in conjunction with one or more visual simulation tools based at least in part on the techniques disclosed herein.

This and other related functionality provided using the techniques disclosed herein can be utilized, for example, in making player acquisition decisions, such as adding or dropping players, based at least in part on recommendations and/or quantified values that are automatically generated by an information processing system.

Another example use case in other embodiments is automatically annotating images, video footage or other data based at least in part on outputs of an action anticipation stage of the type described herein.

Accordingly, information processing systems with machine learning functionality as disclosed herein can be configured to support a wide variety of distinct applications, in numerous diverse contexts. References herein to particular team sports activities, such as volleyball, are by way of illustrative example only, and the disclosed techniques can be adapted for use in any of a wide variety of group activity contexts.

Some additional illustrative embodiments in various contexts will now be described with reference to FIGS. 10 through 14.

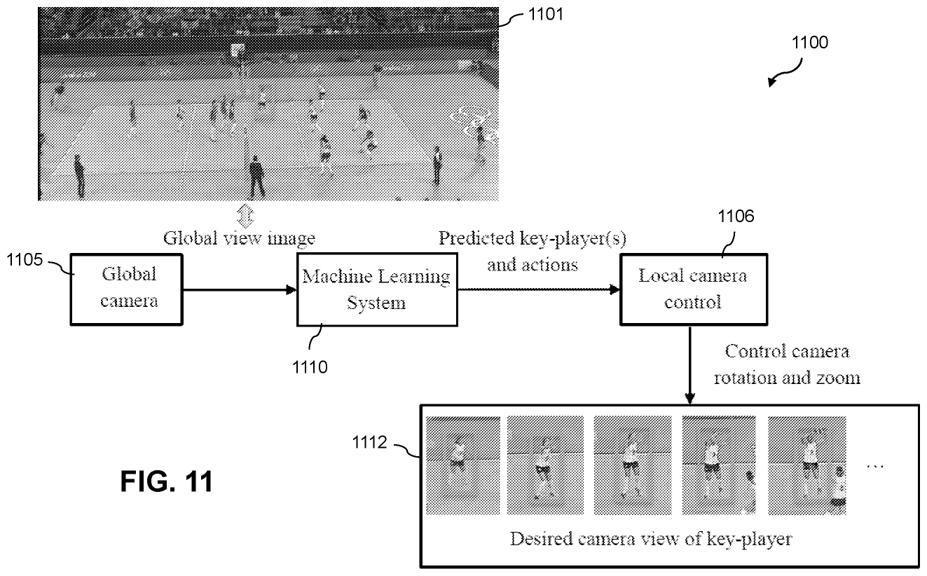

FIGS. 10 and 11 show illustrative embodiments configured to perform camera control in sports photography, with an example process comprising steps 1000 through 1010 being shown in FIG. 10, and an example information processing system 1100 implementing at least a portion of that process being shown in FIG. 11.

The best camera shots in sports immortalize the iconic moments of legendary players. The biggest challenge about sports photography is capturing the fast moments that would be very easily missed. Conventional sports photography largely relies on professional photographers who manually adjust the camera rotation and camera zoom such that players appear at the best position and with proper sizes in an image.

The embodiments of FIGS. 10 and 11 are illustratively configured to dynamically predict the future key players and their actions, where key players refers to players who will exhibit crucial actions that influence the game progress, and to provide a camera control system for automatically tracking key players and taking the best possible shots.

The information processing system 1100 of FIG. 11 more particularly comprises a global camera 1105 that generates global view images such as global view image 1101. The global camera 1105 may be viewed as an example of a data source 105 in the context of the FIG. 1 embodiment. The information processing system 1100 further comprises a machine learning system 1110, which may be viewed as an example of the machine learning system 110 of FIG. 1, and at least one local camera control device 1106, which may be viewed as an example of a controlled system component 106 of FIG. 1.

Referring now to the example process of FIG. 10, in step 1000 a global camera such as global camera 1105 generates global view images. The global view images are processed in step 1002 using a machine learning system such as machine learning system 1110 to anticipate key players and actions using the inference and anticipation techniques disclosed herein. In step 1004, a determination is made as to whether or not the predicted key players are the same as in one or more previous iterations of the process. Responsive to an affirmative determination, the process moves to step 1006 to implement a first control mode, also denoted as Control Mode I, and otherwise the process moves to step 1008 to implement a second control mode, also denoted as Control Mode II.

In Control Mode I of step 1006, the rotation and zoom of one or more local cameras are controlled to maintain the same one or more key players at the appropriate image center and in the desired size for taking the best shots of those key players.

In Control Mode II of step 1008, the rotation of one or more local cameras is controlled to track one or more new key players.

In step 1010, a determination is made as to whether or not the game has ended. Responsive to an affirmative determination, the process ends, and otherwise returns to step 1000 as indicated to initiate an additional iteration of the processing of additional global view images as generated in step 1000.

The embodiments of FIGS. 10 and 11 advantageously provide an automatic camera control system that includes global camera 1105 covering the entire court, illustratively providing a view of all players, and one or multiple local cameras whose rotation and zoom are automatically controlled such that those camera views capture the key players at the desired position with desired size in the image plane.

Accordingly, such embodiments are automatically controlled for tracking key players, illustratively in accordance with the FIG. 10 process. Such a process provides numerous advantages over human photographers. For example, the process can be implemented at least in part on board a mobile platform, such as a drone, with greater access to the best photos. The automatic camera control system can better react to local conditions such as occlusions, while also removing the human from the loop and reducing human workload.

The system configuration of FIG. 11 generally illustrates one possible implementation of Control Mode I of FIG. 10. The player in the bounding box is a future or predicted key player determined using the global view image taken at the current moment. Then, the spatial location of the predicted key player can be used to control a local camera to obtain a dynamically-adjusted desired view of the predicted key player, illustratively resulting in a sequence of images 1112 of the predicted key player.

The automatic camera control system as illustrated in FIGS. 10 and 11 can dynamically predict new key players as time evolves, and then control the local cameras to take best shots of the new key players accordingly. This example system is applicable for controlling one or multiple local cameras. A given such local camera may be viewed as an example of one of the controlled system components 106 of the FIG. 1 embodiment.

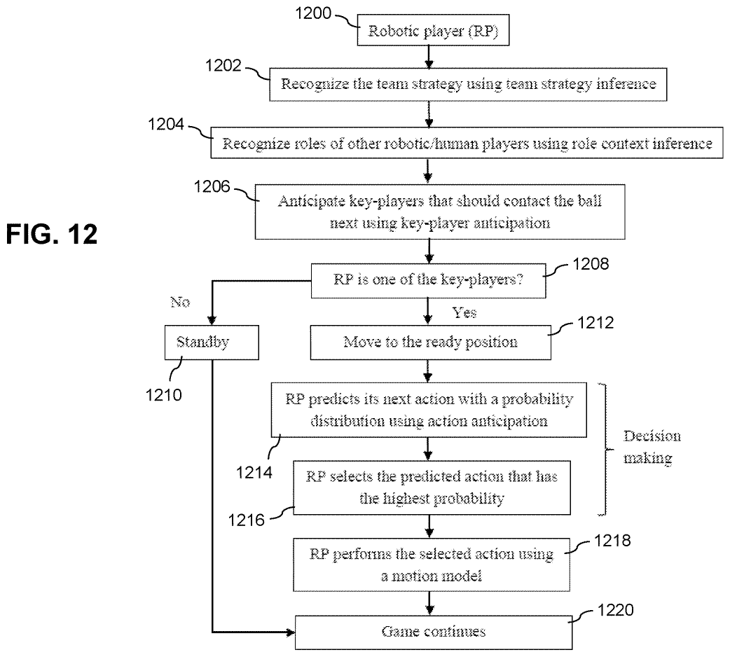

FIG. 12 shows an illustrative embodiment configured to perform decision making for a robotic player (RP) using machine learning based video analysis, detection and prediction as disclosed herein. The RP is illustratively a physical robot that plays with or against human players in a sports game, and the system is configured to determine the future actions of the RP in the sports game. Using a volleyball game as an example, the RP assumes one of the volleyball roles and is equipped with computational software and hardware to implement the disclosed techniques for video analysis, detection and prediction.

The output of the machine learning system in this embodiment illustratively comprises a probability distribution of the RP's future actions, which can be used by a decision-making process for selecting the action with the highest probability as the one to be executed by the RP, as is illustrated in the flow diagram of FIG. 12.

The process as illustrated in FIG. 12 includes steps 1200 through 1220. In step 1200, the RP is initialized. In step 1202, the team strategy is recognized using team strategy inference, and in step 1204, the roles of other robotic and/or human players are recognized using role context inference. In step 1206, key players that are expected to contact the ball are determined using key player anticipation.

A determination is made in step 1208 as to whether or not the RP is one of the key players. Responsive to a negative determination, the process moves to step 1210 to enter a temporary standby mode for the RP, and otherwise moves to step 1212 as indicated. In step 1212, the RP moves to the ready position, and in steps 1214 and 1216 performs decision making operations as indicated. More particularly, in step 1214, the RP predicts its next action with a probability distribution characterizing multiple possible actions, as determined using action anticipation as disclosed herein, and in step 1216, selects the predicted action that has the highest probability based on the probability distribution. The RP in step 1218 performs the selected action using a motion model, and in step 1220 the game continues as indicated. Step 1220 is also reached by the RP after exiting the temporary standby state of step 1210. Although not explicitly shown in the figure, it is assumed that from step 1220, the process illustratively returns to step 1202 for another iteration of the process. Such additional iterations illustratively continue as long as the game lasts for the RP.

Similar techniques can be used to implement automated decision making functionality for non-player characters (NPCs) in sports video games and other types of video games. Such NPCs and the RPs mentioned previously are examples of what are more generally referred to herein as “automated players.”

A given such automated player can therefore comprise, for example, a robotic player in a physical game system or a virtual player in a gaming system. Other types of artificial or automated players may be used. An automated player may be viewed as another example of one of the controlled system components 106 of the FIG. 1 embodiment.

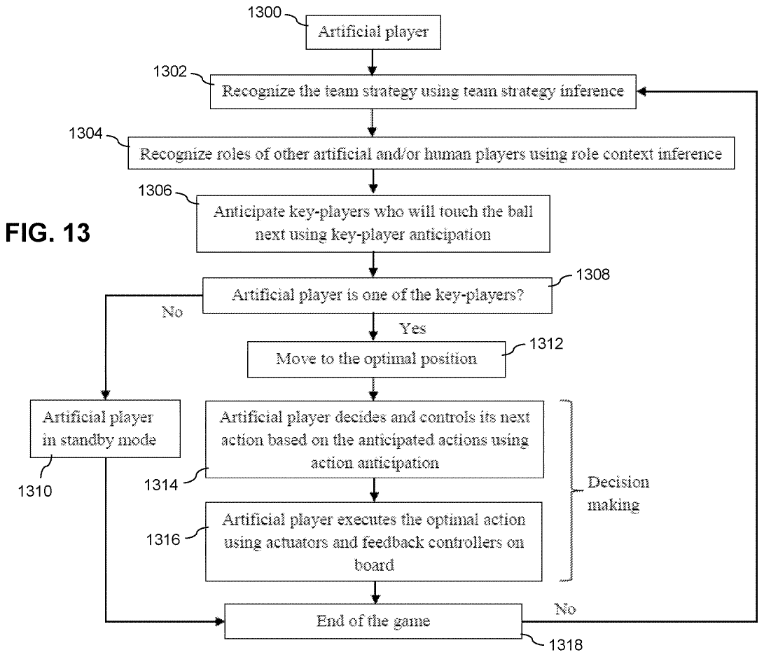

FIG. 13 shows an illustrative embodiment configured to perform decision making for an artificial player, which is considered another example of what is more generally referred to herein as an “automated player.” These techniques can be similarly adapted for use with other types of automated players, such as robotic players.

The FIG. 13 embodiment more particularly illustrates one possible implementation of decision making for artificial players. This process can be used by artificial players (e.g., animated computer players in video games or real physical robots) that play against and/or with humans to plan their future actions intelligently in sports. Using a volleyball game as an example, the artificial player assumes one of the volleyball roles and is equipped with computational software and hardware to implement the disclosed techniques. The process controls the artificial player's future actions optimally, based on probability distributions describing the predictions of the action anticipation algorithm, as illustrated in the figure. Again, this process is applicable to other types of automated players, such as robotic players and NPCs in sports video games.

The process as illustrated in FIG. 13 includes steps 1300 through 1318. In step 1300, the artificial player is initialized. In step 1302, the team strategy is recognized using team strategy inference, and in step 1304, the roles of other artificial and/or human players are recognized using role context inference. In step 1306, key players that are expected to contact the ball are determined using key player anticipation.

A determination is made in step 1308 as to whether or not the artificial player is one of the key players. Responsive to a negative determination, the process moves to step 1310 to enter a temporary standby mode for the artificial player, and otherwise moves to step 1312 as indicated. In step 1312, the artificial player moves to an optimal position, and in steps 1314 and 1316 performs decision making operations as indicated. More particularly, in step 1314, the artificial player decides upon and controls its next action based on anticipated actions determined using action as disclosed herein, and in step 1316, executes an optimal action, illustratively using actuators and feedback controllers, which may be implemented in an on-board arrangement. In step 1318, a determination is made as to whether or not the end of the game has been reached. Step 1318 is also reached by the artificial player after exiting the temporary standby mode of step 1310. Responsive to a negative determination in step 1318, the process illustratively returns to step 1302 for another iteration of the process, and such iterations continue as long as the game lasts.

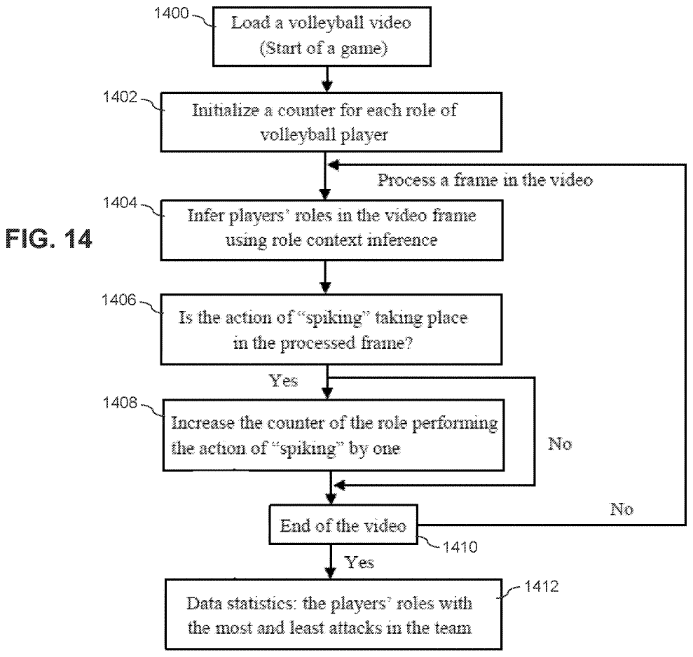

FIG. 14 shows an illustrative embodiment configured to automatically generate player statistics using machine learning based video analysis, detection and prediction in an illustrative embodiment. More particularly, this embodiment provides a process for analyzing the offensive performance of different volleyball roles, although other types of team performance analysis can be implemented using similar techniques.

The process as illustrated in FIG. 14 includes steps 1400 through 1412. In step 1400, a volleyball video is loaded, corresponding to the start of a game. A counter is initialized for each possible player role in step 1402. For a given video frame in the video, step 1404 infers players' roles in the video frame using role context inference as disclosed herein. In step 1406, a determination is made as to whether or not the action of “spiking” is taking place in the given frame. Responsive to an affirmative determination, the process moves to step 1408, and otherwise bypasses step 1408 as shown to reach step 1410. In step 1408, the counter for the role performing the action of “spiking” is increased by one, and the process then moves to step 1410. In step 1410, a determination is made as to whether or not the end of the video has been reached. Responsive to an affirmative determination, the process moves to step 1412 to generate summary data statistics that illustratively characterize the players' roles having the most and least attacks in the team for the processed video. If it is determined in step 1410 that the end of the video has not been reached, the process returns to step 1404 to process another frame in the video, as indicated. In other embodiments, additional or alternative statistics can be generated. For example, a separate set of counters can be maintained for each of the players on the team and for each of the roles that may be taken on by the player.

Sport analysis using the FIG. 14 process and other techniques disclosed herein can inform decision-making and support coaches and players in the training process to improve the performance of both individual players and the entire team. Under conventional practice, such work generally requires human performance analysts to have rich knowledge in sports and a lot of expertise in statistics and software to handle the large amount of data collected in sports events. The disclosed techniques can assist or substitute human experts in analyzing the performance of individual roles using video recordings. For example, the FIG. 14 process can be applied to evaluate a volleyball player's offensive performance by assessing the number of attacks, corresponding to the action of spiking, initiated by different roles, as is shown in the figure. Such data statistics can also provide insight into a team's attacking strategy (e.g., the percentage of left-wing attacks versus right-wing attacks), which can be used to model adversaries for a coach to train “practice teams” to play against the home team.

It is to be appreciated that the particular arrangements described above are examples only, intended to demonstrate utility of illustrative embodiments, and should not be viewed as limiting in any way.

Automated actions taken based on outputs generated by a machine learning system of the type disclosed herein can include particular actions involving interaction between a processing platform implementing the machine learning system and other related equipment utilized in one or more of the applications described above. For example, outputs generated by a machine learning system can control one or more components of a related system. In some embodiments, the machine learning system and the related equipment are implemented on the same processing platform, which may comprise a computer, mobile telephone, camera system, gaming system or other arrangement of one or more processing devices.

As described above, some embodiments disclosed herein are configured not only to recognize team-level events but also to predict action labels for individual key players.

Some embodiments implement an algorithm providing a holistic graphical approach that aggregates both low-level features and hidden variables such as team strategies and player roles in order to predict future actions.

Additionally or alternatively, illustrative embodiments herein utilize player locations as one of multiple visual observations for inferring roles of individual athletes.

These and other embodiments can infer and predict information in a scene that would otherwise be difficult to determine, such as player roles and future actions.

In some embodiments, graphs are constructed for each of a plurality of time steps, where each player is illustratively associated with an observation node representing individual player features and a hidden node representing player role. Player roles inferred in this manner are illustratively utilized to predict future actions of the players, including multiple players from each team that are likely to take certain actions.

Some embodiments implement a graphical model to infer hidden information and feed the resulting hidden information to a supervised learning model for action label generation.

Illustrative embodiments herein provide a data-driven process where implicit information about individuals and teams is learned.

Additionally or alternatively, some embodiments model team interactions and forecast the action of the key players.

These and other embodiments provide an approach that integrates different visual features for player role inference and action prediction.

The above-noted features and advantages of illustrative embodiments may or may not be present in other embodiments.

It should also be understood that the particular arrangements shown and described in conjunction with FIGS. 1 through 14 are presented by way of illustrative example only, and numerous alternative embodiments are possible. The various embodiments disclosed herein should therefore not be construed as limiting in any way. Numerous alternative arrangements of machine learning based video analysis, detection and prediction can be utilized in other embodiments. Those skilled in the art will also recognize that alternative processing operations and associated system configurations can be used in other embodiments.

It is therefore possible that other embodiments may include additional or alternative system elements, relative to the entities of the illustrative embodiments. Accordingly, the particular system configurations and associated algorithm implementations can be varied in other embodiments.

A given processing device or other component of an information processing system as described herein is illustratively configured utilizing a corresponding processing device comprising a processor coupled to a memory. The processor executes software program code stored in the memory in order to control the performance of processing operations and other functionality. The processing device also comprises a network interface that supports communication over one or more networks.

The processor may comprise, for example, a microprocessor, an ASIC, an FPGA, a CPU, a GPU, a TPU, an ALU, a DSP, or other similar processing device component, as well as other types and arrangements of processing circuitry, in any combination. For example, at least a portion of the functionality of at least one machine learning system, and its machine learning algorithms for video analysis, detection and prediction, provided by one or more processing devices as disclosed herein, can be implemented using such circuitry.

The memory stores software program code for execution by the processor in implementing portions of the functionality of the processing device. A given such memory that stores such program code for execution by a corresponding processor is an example of what is more generally referred to herein as a processor-readable storage medium having program code embodied therein, and may comprise, for example, electronic memory such as SRAM, DRAM or other types of random access memory, ROM, flash memory, magnetic memory, optical memory, or other types of storage devices in any combination.

As mentioned previously, articles of manufacture comprising such processor-readable storage media are considered embodiments of the present disclosure. The term “article of manufacture” as used herein should be understood to exclude transitory, propagating signals. Other types of computer program products comprising processor-readable storage media can be implemented in other embodiments.

In addition, embodiments of the present disclosure may be implemented in the form of integrated circuits comprising processing circuitry configured to implement processing operations associated with implementation of a machine learning system.

An information processing system as disclosed herein may be implemented using one or more processing platforms, or portions thereof.

For example, one illustrative embodiment of a processing platform that may be used to implement at least a portion of an information processing system comprises cloud infrastructure including virtual machines implemented using a hypervisor that runs on physical infrastructure. Such virtual machines may comprise respective processing devices that communicate with one another over one or more networks.

The cloud infrastructure in such an embodiment may further comprise one or more sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the information processing system.

Another illustrative embodiment of a processing platform that may be used to implement at least a portion of an information processing system as disclosed herein comprises a plurality of processing devices which communicate with one another over at least one network. Each processing device of the processing platform is assumed to comprise a processor coupled to a memory. A given such network can illustratively include, for example, a global computer network such as the Internet, a WAN, a LAN, a satellite network, a telephone or cable network, a cellular network such as a 4G or 5G network, a wireless network implemented using a wireless protocol such as Bluetooth, WiFi or WiMAX, or various portions or combinations of these and other types of communication networks.

Again, these particular processing platforms are presented by way of example only, and an information processing system may include additional or alternative processing platforms, as well as numerous distinct processing platforms in any combination, with each such platform comprising one or more computers, servers, storage devices or other processing devices.

A given processing platform implementing a machine learning system as disclosed herein can alternatively comprise a single processing device, such as a computer, mobile telephone, camera system, robotic player, gaming system or other processing device, that implements not only the machine learning system but also at least one data source and one or more controlled system components. It is also possible in some embodiments that one or more such system elements can run on or be otherwise supported by cloud infrastructure or other types of virtualization infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in an information processing system. Such components can communicate with other elements of the information processing system over any type of network or other communication media.

As indicated previously, components of the system as disclosed herein can be implemented at least in part in the form of one or more software programs stored in memory and executed by a processor of a processing device. For example, certain functionality disclosed herein can be implemented at least in part in the form of software.

The particular configurations of information processing systems described herein are exemplary only, and a given such system in other embodiments may include other elements in addition to or in place of those specifically shown, including one or more elements of a type commonly found in a conventional implementation of such a system.

For example, in some embodiments, an information processing system may be configured to utilize the disclosed techniques to provide additional or alternative functionality in other contexts.

It should again be emphasized that the embodiments of the present disclosure as described herein are intended to be illustrative only. Other embodiments of the present disclosure can be implemented utilizing a wide variety of different types and arrangements of information processing systems, networks and processing devices than those utilized in the particular illustrative embodiments described herein, and in numerous alternative processing contexts. In addition, the particular assumptions made herein in the context of describing certain embodiments need not apply in other embodiments. These and numerous other alternative embodiments will be readily apparent to those skilled in the art.

What is claimed is:

1. A method comprising:
obtaining video data from one or more data sources;
processing the obtained video data in a machine learning system comprising an inference stage and an anticipation stage;
the inference stage being configured to assign one or more labels to at least one of a group activity and an individual activity detected in the obtained video data;
the anticipation stage being configured to predict one or more future actions relating to at least one of the group activity and the individual activity based at least in part on the one or more labels assigned in the inference stage; and
generating at least one control signal based at least in part on the predicted one or more future actions;
wherein the method is performed by at least one processing device comprising a processor coupled to a memory.

2. The method of claim 1 wherein the control signal triggers at least one automated action within said at least one processing device.

3. The method of claim 1 wherein the control signal is transmitted over a network from a first processing device that implements at least a portion of the machine learning system to trigger at least one automated action in a second processing device that comprises at least one controlled system component.

4. The method of claim 1 wherein the inference stage is configured to assign a group activity label to a group activity utilizing a multi-class classifier.

5. The method of claim 1 wherein the inference stage is configured to assign an individual activity label to an individual activity utilizing a spatio-temporal Markov Random Field (MRF) model.

6. The method of claim 1 wherein the anticipation stage is configured to predict the one or more future actions utilizing a multi-layer perceptron.

7. The method of claim 1 wherein the anticipation stage is configured to predict the one or more future actions utilizing a neural network comprising a first branch and a second branch, the first and second branches being arranged at least in part in parallel with one another and each configured to receive an input vector, and further wherein the first branch is configured to generate a probability distribution for a discrete action variable and the second branch is configured to generate one or more scalar values for one or more respective continuous timing variables.

8. The method of claim 7 wherein the first branch comprises:
one or more hidden layers configured to map the input vector to a first latent vector using a first set of hidden layer weights and a first hidden layer activation function; and
an output layer configured to generate the probability distribution for the discrete action variable from the first latent vector using a first set of output layer weights and a first output layer activation function.

9. The method of claim 7 wherein the second branch comprises:
one or more hidden layers configured to map the input vector to a second latent vector using a second set of hidden layer weights and a second hidden layer activation function; and
an output layer configured to generate the one or more scalar values for the one or more respective continuous timing variables from the second latent vector using a second set of output layer weights and a second output layer activation function.

10. The method of claim 7 wherein the neural network is trained at least in part utilizing an anticipation loss that comprises a function of a cross-entropy loss of the discrete action variable and a mean squared loss of the one or more respective continuous timing variables.

11. The method of claim 1 wherein the group activity comprises a team sports activity and the individual activity comprises a player activity associated with the team sports activity.

12. The method of claim 11 wherein the inference stage is configured to assign a team activity label to the team sports activity and to assign a role label to each of a plurality of players associated with respective player activities of the team sports activity.

13. The method of claim 11 wherein the anticipation stage is configured to predict the one or more future actions by predicting a sub-group of key players in a plurality of players and predicting at least one future action for at least one of the key players based at least in part on an inferred team activity label and one or more inferred role labels for respective ones of the plurality of players.

14. The method of claim 1 wherein the anticipation stage is configured to predict the one or more future actions based at least in part on a probability distribution of multiple predicted actions.

15. The method of claim 14 wherein the control signal is generated based at least in part on selection of a particular one of the multiple predicted actions utilizing the probability distribution.

16. The method of claim 1 wherein the control signal comprises at least one camera control signal configured to automatically adjust one or more parameters of at least one camera system.

17. The method of claim 1 wherein the control signal comprises at least one automated player control signal configured to automatically adjust one or more parameters of at least one automated player, wherein the automated player comprises one of a robotic player in a physical game system and a virtual player in a gaming system.

18. The method of claim 1 wherein the assignment of one or more labels and the prediction of one or more future actions are repeated for each of a plurality of frames of the obtained video data.

19. The method of claim 1 wherein the machine learning system further comprises a recognition and estimation stage that extracts a first set of features from the obtained video data and further wherein the first set of features is combined for further processing in the inference and anticipation stages with at least a second set of features extracted from additional data obtained at least in part utilizing one or more sensors.

20. The method of claim 19 wherein the one or more sensors comprise at least one of one or more wearable devices, one or more tracking devices, one or more trajectory-determination devices, one or more distance-measuring devices, one or more health-monitoring devices and one or more auditory devices.

21. The method of claim 1 wherein generating at least one control signal based at least in part on the predicted one or more future actions comprises incrementing at least one counter associated with at least one performance metric of at least one of the group activity and the individual activity.

22. The method of claim 1 wherein generating at least one control signal based at least in part on the predicted one or more future actions comprises automatically populating at least a portion of at least one performance data structure for at least one of the group activity and the individual activity.

23. The method of claim 1 further comprising generating one or more team formation recommendations based at least in part on the one or more future actions.

24. The method of claim 1 further comprising quantifying values of one or more players of a sports team based at least in part on the one or more future actions.

25. A system comprising:
at least one processing device comprising a processor coupled to a memory;
the processing device being configured:
to obtain video data from one or more data sources;
to process the obtained video data in a machine learning system comprising an inference stage and an anticipation stage;
the inference stage being configured to assign one or more labels to at least one of a group activity and an individual activity detected in the obtained video data;
the anticipation stage being configured to predict one or more future actions relating to at least one of the group activity and the individual activity based at least in part on the one or more labels assigned in the inference stage; and
to generate at least one control signal based at least in part on the predicted one or more future actions.

26. The system of claim 25 wherein the group activity comprises a team sports activity and the individual activity comprises a player activity associated with the team sports activity.

27. The system of claim 26 wherein the inference stage is configured to assign a team activity label to the team sports activity and to assign a role label to each of a plurality of players associated with respective player activities of the team sports activity, and the anticipation stage is configured to predict the one or more future actions by predicting a sub-group of key players in the plurality of players and predicting at least one future action for at least one of the key players based at least in part on an inferred team activity label and one or more inferred role labels for respective ones of the plurality of players.

28. A computer program product comprising a non-transitory processor-readable storage medium having stored therein program code of one or more software programs, wherein the program code, when executed by at least one processing device comprising a processor coupled to a memory, causes the processing device:
to obtain video data from one or more data sources;
to process the obtained video data in a machine learning system comprising an inference stage and an anticipation stage;
the inference stage being configured to assign one or more labels to at least one of a group activity and an individual activity detected in the obtained video data;
the anticipation stage being configured to predict one or more future actions relating to at least one of the group activity and the individual activity based at least in part on the one or more labels assigned in the inference stage; and
to generate at least one control signal based at least in part on the predicted one or more future actions.

29. The computer program product of claim 28 wherein the group activity comprises a team sports activity and the individual activity comprises a player activity associated with the team sports activity.

30. The computer program product of claim 29 wherein the inference stage is configured to assign a team activity label to the team sports activity and to assign a role label to each of a plurality of players associated with respective player activities of the team sports activity, and the anticipation stage is configured to predict the one or more future actions by predicting a sub-group of key players in the plurality of players and predicting at least one future action for at least one of the key players based at least in part on an inferred team activity label and one or more inferred role labels for respective ones of the plurality of players.
